(19) United States
(12) Patent Application Publication
(10) Pub. No.: US 2015/0134483 A1
(43) Pub. Date: May 14, 2015

(54) SYSTEM AND METHODS FOR PROPERTY MORTGAGE MATCHING AND COORDINATION

(71) Applicant: Richard Barenblatt, New York, NY (US)

(72) Inventor: Richard Barenblatt, New York, NY (US)

(21) Appl. No.: 14/080,567

(22) Filed: Nov. 14, 2013

(51) Int. Cl. G06Q 40/02; G06Q 30/06

(52) U.S. Cl. CPC G06Q 40/025; G06Q 30/0613
USPC 705/26.41

(57) ABSTRACT

The disclosed computer system facilitates the matching of prospective borrowers in real estate transactions with mortgage professionals that arrange mortgages and/or financing. Borrowers and mortgage professionals may access the system via a website to execute searches and/or to register and update their profiles. Information relating to borrowers and/or mortgage professionals is stored in a database component of the disclosed system. In one embodiment, prospective borrowers interested in buying or refinancing a specific property may discover mortgage professionals that have previously worked with that property. In another embodiment, the system matches borrowers and mortgage professionals based on pre-selected criteria. In another embodiment, the system automatically matches borrowers and mortgage professionals based on information from their profiles.

### FIELD OF INVENTION

This invention relates to a computer system for coordinating real estate lending and property transaction operations.

### BACKGROUND

By way of background, the process of acquiring property includes a number of steps and decisions that must be successfully navigated by both buyer and seller in order to complete the transaction.

Parties to a real estate purchase may include the prospective buyer, the seller, a real estate broker, a mortgage broker, attorneys, and a lender. Other players in the transaction may include a board of directors if the property purchased is a co-operative association (“co-op”) or condominium (“condo”), a managing agent if the property is a co-op or condo, accountants, attorneys, and other professionals. A successful purchase requires careful management and coordination of the various players.

A prospective buyer may turn to various sources of information regarding available property. The buyer may turn to newspapers, websites, brochures, real estate brokers, or even the property owners themselves if the buyer knows their location and contact information. For example, the buyer may visit several properties with the help of a real estate broker whose job entails introducing and connecting prospective buyers with property being sold. Once the buyer selects a property to purchase, he or she then negotiates the purchase price and conditions. Buying property can be achieved by paying for the property in full, by borrowing money from a lender (commonly referred to as a mortgage), or by some combination of these options, such as a rent-to-buy transaction where a certain portion of monthly rent counts toward the down payment toward a mortgage on the property.

In mortgage situations, a buyer applies for a loan from a lender, such as a bank or credit union, to purchase property. Typically, banks require buyers to provide a down payment on the property, with the amounts ranging from 10-20% or higher. For certain, specially designated properties, banks may allow a lower down payment. Several factors influence a bank's decision on whether to approve a requested loan. For example, the buyer's financial, employment, and credit history situations play a major role in most bank's decision-making Other factors include the purchase price of the property, its location, condition, recent sales comparables, and various other aspects that may influence the value of the property. This data is important to a bank because as part of the lending process, the bank will issue a loan to the buyer in return for a promise to pay back the loan, where the purchased property will be used as collateral to secure the loan. In other words, if the buyer is unable to make mortgage payments to the bank, the bank may take possession of the property and evict the buyer, in a process known as foreclosure.

When processing loans for co-op and condo properties, banks typically pursue more diligence than with single family or free-standing houses because co-op and condo apartments are usually found in larger buildings with dozens, and possibly hundreds of units. In the co-op and condo scenario, the bank must evaluate not only the individual unit being purchased, but also the financial health of the building itself, which normally entails reviewing a questionnaire provided by the managing agent, a current budget, financial statements, the building's insurance, and numerous other factors that may impact the value of an individual unit being purchased. This review process may lead to a lender rejecting the requested loan not based on the buyer's characteristics or characteristics of the individual unit being purchased, but rather based on the overall condo or co-op property which may be a risky investment. Examples of factors considered to be risky include: litigation; percentage of commercial versus residential space; percentage of commercial versus residential income; number of units delinquent on their monthly dues; number of rental units; ownership by a single entity or individual of a high percentage of the units; insufficient financial reserves; and whether the building is running at a deficit or loss. To this end, many first time condo and co-op buyers are surprised by the amount of time required to process their mortgage applications, and by unexpected rejections based on circumstances outside of their control.

To complicate the process, not all banks provide mortgage services in all states, locations, zip codes, or neighborhoods. Moreover, some banks do not lend to buyers of co-op and condo properties. To help navigate the process, buyers sometimes turn to mortgage brokers who may, or may not, be knowledgeable in the geographic area where the property is being sold, the property type being acquired, or the likelihood of the buyer obtaining the desired mortgage. These obstacles frequently cause frustration, delays, and stress to the buyers and sellers, result in unnecessary expenditures on attorneys and other professionals, and drain a significant amount of time and energy from all involved without producing a satisfactory result. The buyer could risk losing their down payment or even the property. To this end, there exists a need for more efficient coordination of parties involved in the mortgage process and for other improvements in the property buying process.

### SUMMARY

Generally, the presently disclosed invention is a computer-based system designed to facilitate real estate lending and transaction operations, by offering useful services to prospective borrowers and mortgage professionals. In one embodiment, the disclosed system solves the problems identified above by connecting prospective borrowers with mortgage professionals who are known to have handled transactions in properties and/or areas the borrowers are interested in. In another embodiment, the disclosed system connects prospective borrowers with mortgage professionals based on other criteria relevant to real estate transactions. In other embodiments, the disclosed system connects mortgage professionals with prospective borrower clients.

In one embodiment, the disclosed system allows prospective borrowers to search for mortgage professionals based on location and/or a specific property address. In another embodiment, the present invention provides a matching system for connecting prospective borrowers with mortgage professionals based on a set of parameters. In another embodiment, the matching system automatically connects prospective borrowers with mortgage professionals based on the borrowers' and professionals' profiles. In another embodiment, the disclosed system allows mortgage professionals to seek out prospective borrower clients based on a set of parameters. In another embodiment, the disclosed system automatically matches mortgage professionals with prospective borrowers based on the professionals' and borrowers' profiles.

In another embodiment, the disclosed system facilitates the matching of prospective borrowers with appropriate properties based on requirements established by the properties' owners and/or managing boards of directors. In another embodiment, the system facilitates a contextual offering of additional professional services to prospective borrowers. In another embodiment, the system matches prospective borrowers with other service providers based on the borrowers' profiles.

### BRIEF DESCRIPTION OF THE DRAWINGS

FIG. 1A illustrates one embodiment of a server configuration used in the disclosed system.

FIG. 1B illustrates a second embodiment of a server configuration used in the disclosed system.

FIG. 1C illustrates a third embodiment of a server configuration used in the disclosed system.

FIG. 2 is a flowchart illustrating various services accessible to users in the preferred embodiment of the invention.

FIG. 3A illustrates several methods of presenting services disclosed herein to mortgage professional users.

FIG. 3B illustrates several methods of presenting services disclosed herein to prospective borrower users.

FIG. 4 is a flowchart illustrating one embodiment of user signup and registration for the mortgage professional services component of the disclosed system

FIG. 5 is a flowchart illustrating one embodiment of user signup and registration for the borrower services component of the disclosed system.

FIG. 6A illustrates one embodiment of a database configuration and structure for storing mortgage professional profiles.

FIG. 6B illustrates one embodiment of a database configuration and structure for storing borrower profiles.

FIG. 7 is a flowchart illustrating one embodiment of process steps performed by the disclosed system in providing search and/or matching services to mortgage professionals.

FIG. 8 is a flowchart illustrating one embodiment of process steps performed by the disclosed system in providing search and/or matching services to prospective borrowers.

FIG. 9 illustrates one embodiment of a match engine configured to provide matching services for mortgage professionals.

FIG. 10 illustrates one embodiment of a match engine configured to provide matching services for prospective borrowers.

FIG. 11 is a screenshot of one embodiment of the homepage of the website interface for the disclosed system.

FIG. 12 is a screenshot of a webpage information screen for mortgage professionals in the illustrated embodiment of the disclosed system.

FIG. 13 is a screenshot of an initial registration webpage for mortgage professionals in the illustrated embodiment of the disclosed system.

FIG. 14 is a screenshot of a second registration webpage for mortgage professionals in the illustrated embodiment of the disclosed system.

FIG. 15 is a screenshot of a third registration webpage for mortgage professionals in the illustrated embodiment of the disclosed system.

FIG. 16 is a screenshot of a webpage for step one of the transactions upload process in the illustrated embodiment of the disclosed system.

FIG. 17 is a screenshot of a webpage for step two of the transactions upload process in the illustrated embodiment of the disclosed system.

FIG. 18 is a screenshot of a webpage for step three of the transactions upload process in the illustrated embodiment of the disclosed system.

FIG. 19 is a screenshot of a first warning screen provided by the website with respect to certain uploaded transactions in the illustrated embodiment of the disclosed system.

FIG. 20 is a screenshot of a second warning screen provided by the website with respect to a specific uploaded transaction in the illustrated embodiment of the disclosed system.

FIG. 21 is a screenshot illustrating one embodiment of a successful upload of a transactions file in the disclosed system.

FIG. 22 is a screenshot illustrating one embodiment of a dashboard for a profile of a mortgage professional available after login.

FIG. 23 is a screenshot illustrating one embodiment of a webpage configured to edit a mortgage professional's profile.

FIG. 24 is a screenshot illustrating a one embodiment of a webpage listing uploaded and/or entered transactions of a mortgage professional with an error indicator.

FIG. 25 is a screenshot illustrating a one embodiment of a webpage listing uploaded and/or entered transactions of a mortgage professional.

FIG. 26 is a screenshot of one embodiment of a security control panel for a mortgage professional's profile.

FIG. 27 is a screenshot of one embodiment of a webpage listing search results for mortgage professionals based on an entered address.

FIG. 28 is a screenshot of one embodiment of a publicly available profile webpage for a mortgage professional.

FIG. 29 is a screenshot of one embodiment of a webpage inviting the user to subscribe to information about a specific property.

FIG. 30 illustrates one embodiment of a match engine configured to provide buyer-to-building matching services.

### DETAILED DESCRIPTION

Generally, the presently disclosed systems and methods, in various embodiments, address several challenges typically experienced by mortgage applicants when buying real property. For example, in certain embodiments, the disclosed system and methods facilitate connections between prospective borrowers and mortgage professionals. For the purpose of brevity and convenience, various embodiments of the present invention may be referred to as the WhoLendsHere system or “WLH.” A prospective borrower may be referred to as “PB” and a mortgage professional may be referred to as an “MP” herein. Naming conventions, as used herein, are not intended to narrow the scope of the present invention, but rather are used for brevity and convenience.

### System Architecture

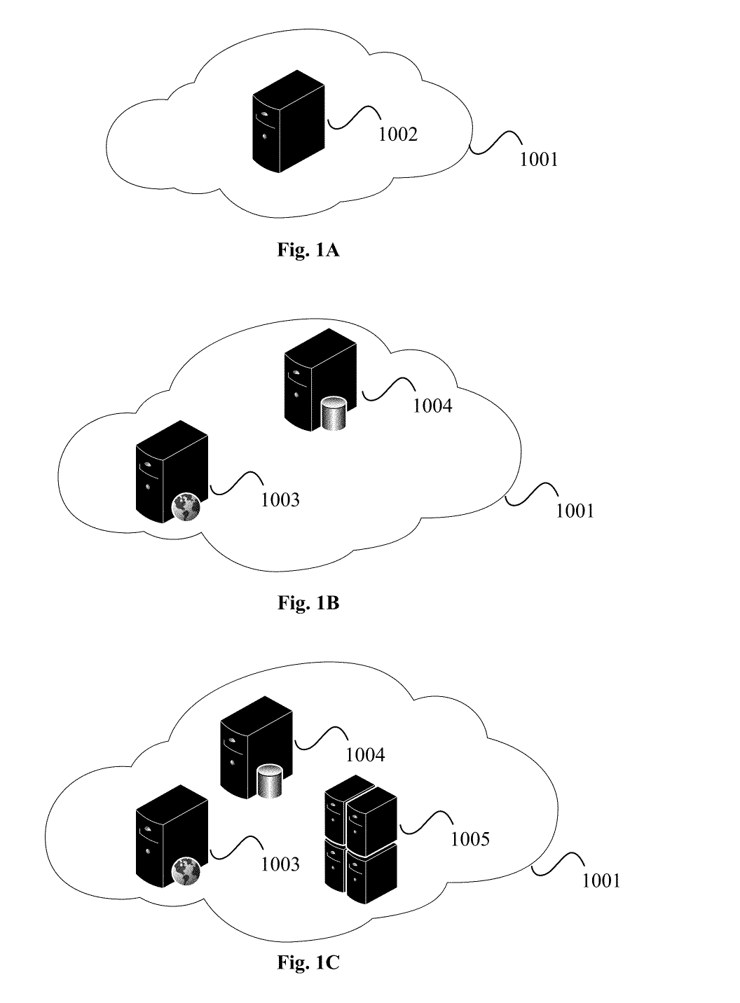

The WLH system is a combination of hardware and software, wherein certain components, including the user interface, are software modules configured to run on a variety of computer hardware platforms. FIG. 1A illustrates one embodiment of a server configuration implemented to support WLH. Here, cloud 1001 refers to a computer network, which can be an internal LAN disconnected from the Internet, or preferably a network with an Internet connection, so that the WLH system can be accessed by outside users. Computer 1002 is a stand-alone server, configured to provide web access, database, and application services. The configuration illustrated in FIG. 1A is acceptable for a low traffic implementation of WLH, without the need for significant processing power or load balancing.

In FIG. 1B, the network 1001 comprises a web server 1003 and a database server 1004. Here, web server 1003 handles incoming web requests, leaving database server 1004 to process data queries and other database operations discussed herein. The configuration illustrated in FIG. 1B offers greater performance and agility than the system in FIG. 1A, since various WLH features may be distributed between two servers.

FIG. 1C illustrates a distributed system, where network 1001 comprises web server 1003 and database server 1004 previously seen in FIG. 1B, but adds application server 1005. Application server 1005 may take over some of the duties previously carried by servers 1002, 1003, and 1004. In this configuration, the WLH system will not encounter significant bottlenecks and should experience optimal performance. One of ordinary skill in the art will recognize that various modifications to the server configurations illustrated in FIGS. 1A-1C are possible, including added scalability, various security devices, combinations of servers, and distribution of responsibilities between the various servers.

Turning to the WLH system, in the preferred embodiment, the present invention is a computer system accessible by users through a network via a web-based interface. Users of the system may include prospective borrowers looking for a mortgage, and mortgage professionals that assist borrowers and owners interested in refinancing an existing mortgage. For the purpose of consistency and brevity, the starting point in a user's navigation of the presently disclosed system will be referred to as the “home screen” or “homepage” herein. The home screen is preferably accessible via a web browser such as Internet Explorer, Google Chrome, Fire Fox, or Apple Safari, whether the present system is accessible via the public Internet, or hosted on an internal network. In other embodiments, the WLH system may be accessible via a mobile app configured to run on a mobile operating system such as Google Android, Apple iOS, or Windows Phone. In a mobile app embodiment, the homepage or home screen refers to the main screen presented to the user by the app.

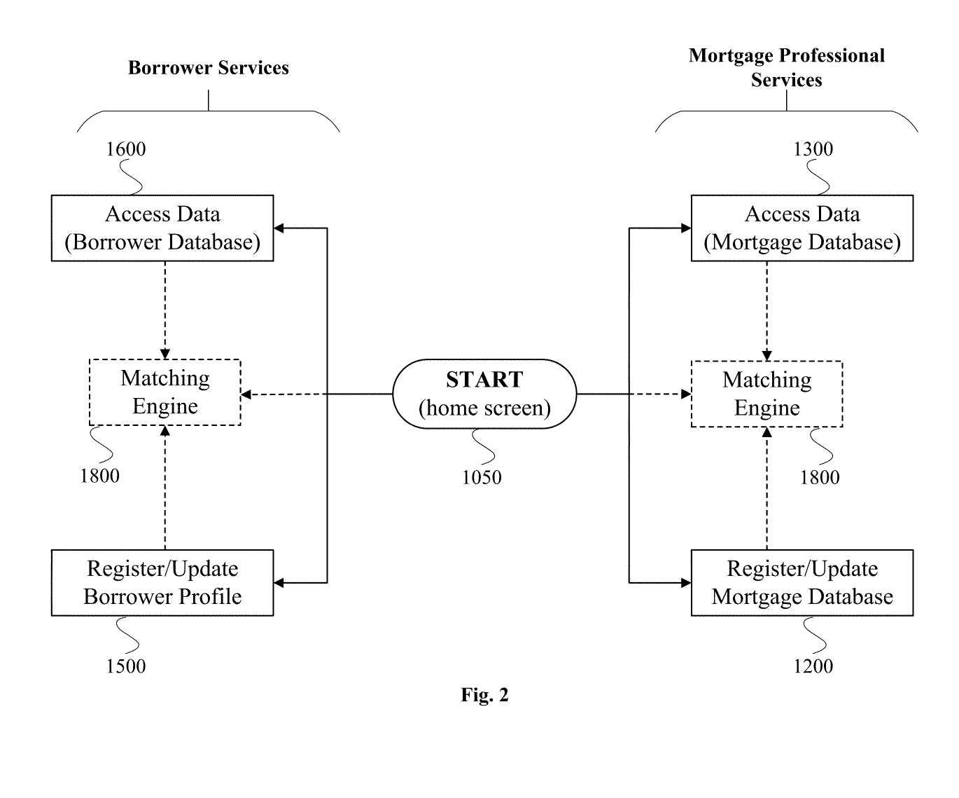

Generally, when users of the system access the home screen, they are presented with the ability to access separate services, or portals, of information, depending on whether they are borrowers or mortgage professionals. The various services presented to users are conceptually illustrated in FIG. 2. When a user accesses the home screen 1050, the system may provide access to services labeled as Mortgage Professional Services and Borrower Services at the top of FIG. 2.

In the preferred embodiment, Mortgage Professional Services presented to the user include the ability to register and/or update their profiles in the mortgage database (1200), access data from the mortgage services database (1300), and access an optional matching engine (1800). The Borrower Services presented to the user include the ability to register and/or update their profiles in the borrower database (1500), access data from the borrower database (1600), and access an optional matching engine (1800). It should be noted that FIG. 2 is not a flowchart illustrating the precise steps that a user must take in order to access the various services. Rather, FIG. 2 conceptually illustrates the mostly separate nature of services offered to the two types of users (borrowers and mortgage professionals).

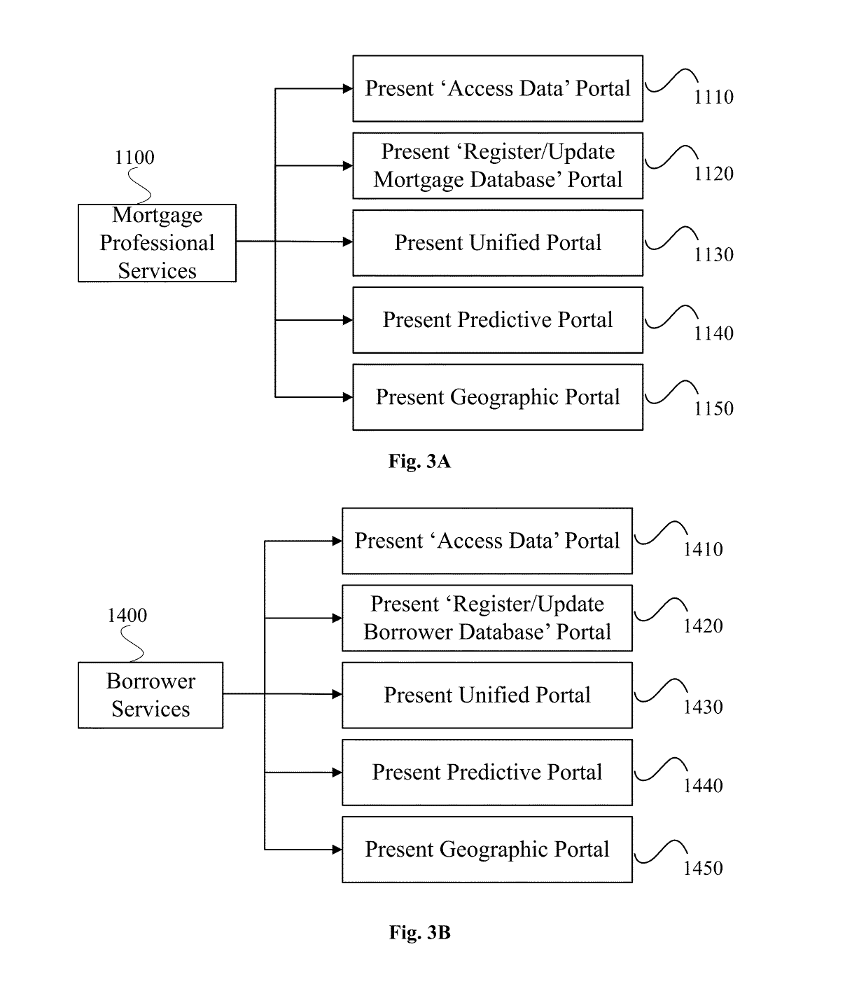

As a general matter, the WLH system is flexible by design, to permit various services, and combinations of services, to be presented to users. The offered services may vary by implementation, and business needs of the organization implementing a WLH system. Thus, in some implementations, the server components of the WLH system may be capable of certain functionality that is not offered to the user via the graphical interface. For example, in some embodiments, the WLH system does not permit MP users to search for PB users. It will be understood that other interfaces may be required based on the business use of the system. Accordingly, the present disclosure of the WLH system provides several different user interface portals that may be used to offer various WLH services, as shown in FIGS. 3A and 3B.

FIG. 3A illustrates several possible methods of presenting services to MP users. MP users may be presented with an ‘Access Data’ Portal 1110, a ‘Register/Update Mortgage Database’ Portal 1120, a Unified Portal 1130, Predictive Portal 1140, and/or a Geographic Portal 1150. A portal, as referred to herein, is a graphical user interface accessible by the user, in the form of a hyperlink, a text box, a dialog box, a portion of a website, an entire website, or some other user interface. One of ordinary skill in the art will recognize that a number of different portals and interfaces may be used to provide access to services over a computer network.

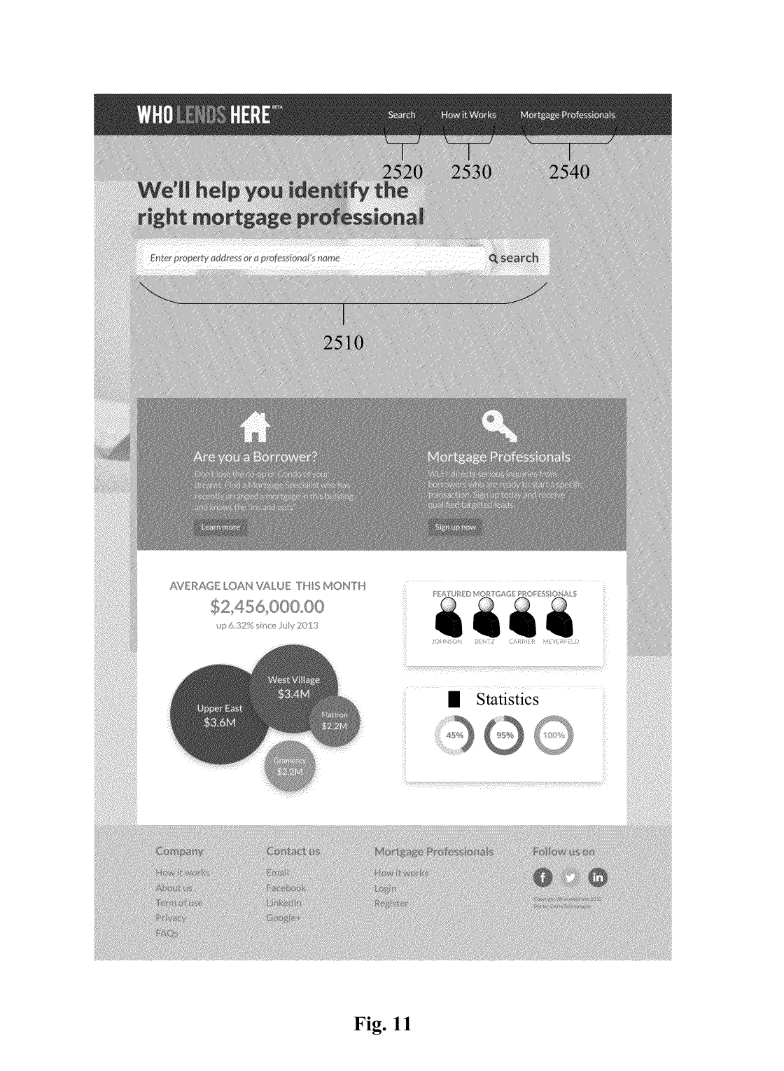

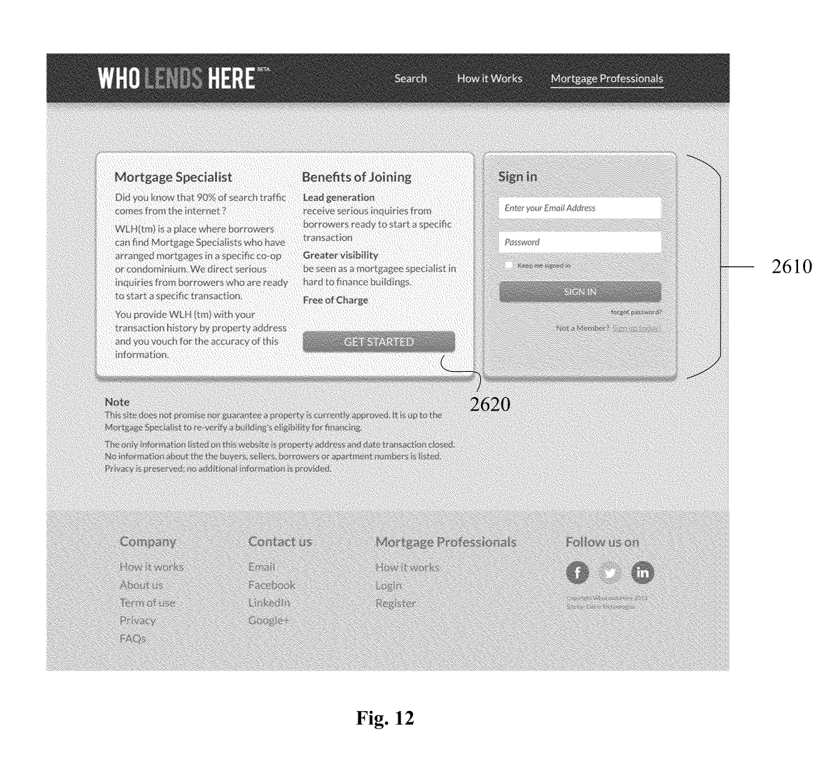

In the context of Mortgage Professional Services, the ‘Access Data’ Portal 1110 may be a hyperlink labeled ‘Mortgage Professionals’ (as illustrated by hyperlink 2540 in FIG. 11) which directs the web browser to a specific webpage dedicated to those services. ‘Register/Update Mortgage Database’ Portal 1120 may be a hyperlink labeled appropriately, and directing the web browser to a specific webpage dedicated to those services. For example, in the embodiment illustrated in FIG. 12, GET STARTED button 2620 starts the registration process, as described below. Unified Portal 1130 may be a webpage that includes all or most user-accessible features of the system. For example, in one embodiment the unified portal may provide the user with choices on whether to access mortgage database data, to update the database, search for various entries right from the portal, and other features of the system. In a Predictive Portal 1140, the system presents the user with an interface and access options that are based on that user's previous interactions with the system. For example, if the user previously spent significant time searching for borrowers based on zip codes, the predictive portal may present the user with a dialog box requesting the user to enter a zip code. Predictions may be based on usage patterns, records of services used, the percentage of time devoted to a specific service, and other factors. Geographic Portal 1150 may present the user with a map of the area where the user is located, and optionally with a search box located on or next to the map. In this way, the user will be presented with a geographical perspective on services offered by the system, and may access information by browsing the map or searching for specific information as it relates to a specific location. It will be understood that instead of providing dedicated webpages for portals outlined above, the system may present the user with an input and/or navigation area on the same page without redirecting the web browser to a separate page.

FIG. 3B illustrates several methods of presenting services disclosed herein to prospective borrower users. PB users may be presented with an ‘Access Data’ Portal 1410, a ‘Register/Update Borrower Database’ Portal 1420, a Unified Portal 1430, Predictive Portal 1440, and/or a Geographic Portal 1450. As above, one of ordinary skill in the art will recognize that a number of different portals and interfaces may be used to provide access to services over a computer network.

In the context of Borrower Services, the ‘Access Data’ Portal 1410 may be a hyperlink labeled ‘Borrower Services’ which directs the web browser to a specific webpage dedicated to those services. ‘Register/Update Borrower Database’ Portal 1420 may be a hyperlink labeled appropriately, and directing the web browser to a specific webpage dedicated to those services. For example, the user may be invited to update his or her borrower profile. Unified Portal 1430 may be a webpage that includes all or most user-accessible features of the system. For example, in one embodiment the unified portal may provide the user with choices on whether to access data, to update the database, search for various entries right from the portal, and other features of the system. In a Predictive Portal 1440, the system presents the user with an interface and access options that are based on that user's previous interactions with the system. For example, if the user previously spent significant time searching for properties based on zip codes, the predictive portal may present the user with a dialog box requesting the user to enter a zip code. Predictions may be based on usage patterns, records of services used, the percentage of time devoted to a specific service, and other factors. Geographic Portal 1450 may present the user with a map of the area where the user is located, and optionally with a search box located on or next to the map. In this way, the user will be presented with a geographical perspective on services offered by the system, and may access information by browsing the map or searching for specific information as it relates to a specific location. In the embodiment illustrated in FIG. 11, search box 2510 acts as a geographic portal, allowing PB users to search for mortgage professionals by address. It will be understood that instead of providing dedicated webpages for portals outlined above, the system may present the user with an input and/or navigation area on the same page without redirecting the web browser to a separate page.

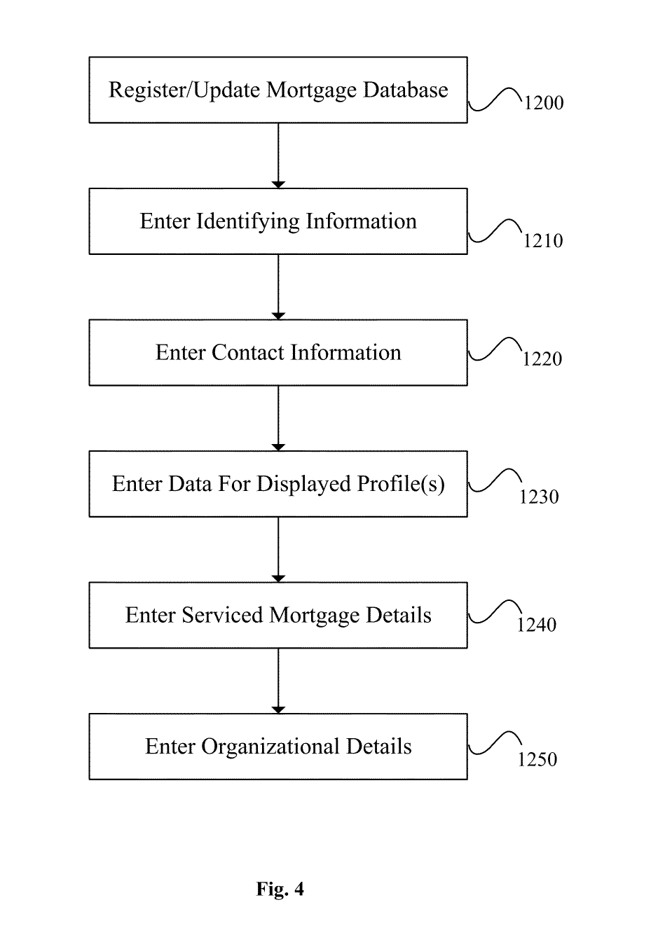

In the preferred embodiment, the WLH system and its user interfaces are configured to provide a simple and user friendly way of signing up to use the offered services. FIG. 4 is a flowchart illustrating one embodiment of user signup and registration for the mortgage professional services component of the disclosed system. In this embodiment, the MP user chooses to ‘Register/Update Mortgage Database’ from a variety of interface options noted previously, with one embodiment of the MP registration process being illustrated in FIGS. 12-15. At step 1210, the system interface, preferably a website, asks the user to enter identifying information, such as their name. At step 1220, the website requests the user to enter his or her contact information, such as an e-mail address, telephone and fax number, or mailing address. Since one feature of the present invention is the ability to present a mortgage professional's profile on the website, at step 1230, the website requests the user to provide data for the user's displayed profile. This data may include information about the professional's employer, their license number (such as a Nationwide Mortgage Licensing System and Registry (“NMLS”) number), and a description of their area of expertise, together with other related information. At step 1240, the professional is offered the opportunity to provide details about the mortgages and/or properties that the professional has serviced. At step 1250, the professional is asked to provide details about his or her organization, including information about their branch offices, affiliations, and other related information. It will be understood that some of the information requested at step 1250 may also, or in the alternative, be requested at step 1230, or vice versa. It will also be understood that steps similar to 1210-1250 may be used to update an already existing profile of a mortgage professional in the database. It will be further understood that steps 1210-1250 may be performed in a different order than illustrated in FIG. 4.

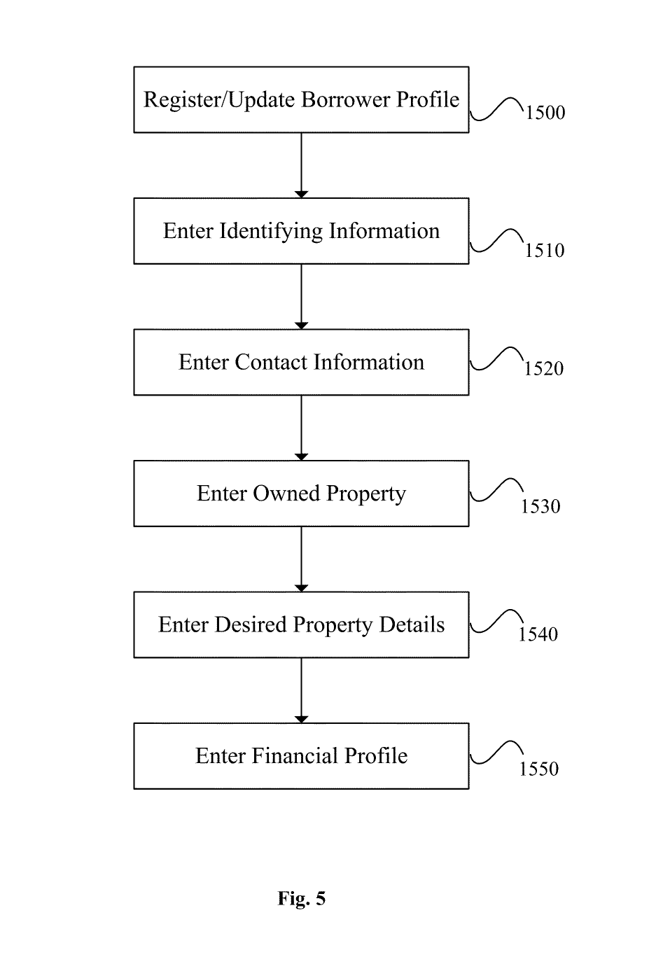

Potential borrowers are also encouraged to establish a profile, similarly to the mortgage professional profiles discussed above, but with a different focus. FIG. 5 is a flowchart illustrating one embodiment of user signup and registration for the borrower services component of the disclosed system. In this embodiment, the PB user chooses to ‘Register/Update Borrower Profile’ from a variety of interface options noted previously, indicated as step 1500. At step 1510, the system interface, preferably a website, asks the user to enter identifying information, such as their name and possibly a social security number. At step 1520, the website requests the user to enter his or her contact information, such as an e-mail address, telephone and fax number, or mailing address. At step 1530, the website requests the user to provide information regarding property owned by the user, such as property type, location, address, purchase price, and other details pertinent to property ownership. At step 1540, the user is offered the opportunity to provide details about his or her desired properties, such as property type, size, location, amenities, price, and other features. At step 1550, the borrower user is asked to provide his or her financial information, such as annual income, current debt, credit usage, liquid assets, social security number if it was not collected earlier, and other data relevant to the ability to obtain a mortgage and/or qualify for a co-op or condo. It will be understood that some of the information requested at step 1550 may also, or in the alternative, be requested at step 1510, or other steps. It will also be understood that steps similar to 1510-1550 may be used to update an already existing profile of a user in the borrower database. It will be further understood that steps 1510-1550 may be performed in a different order than illustrated in FIG. 5.

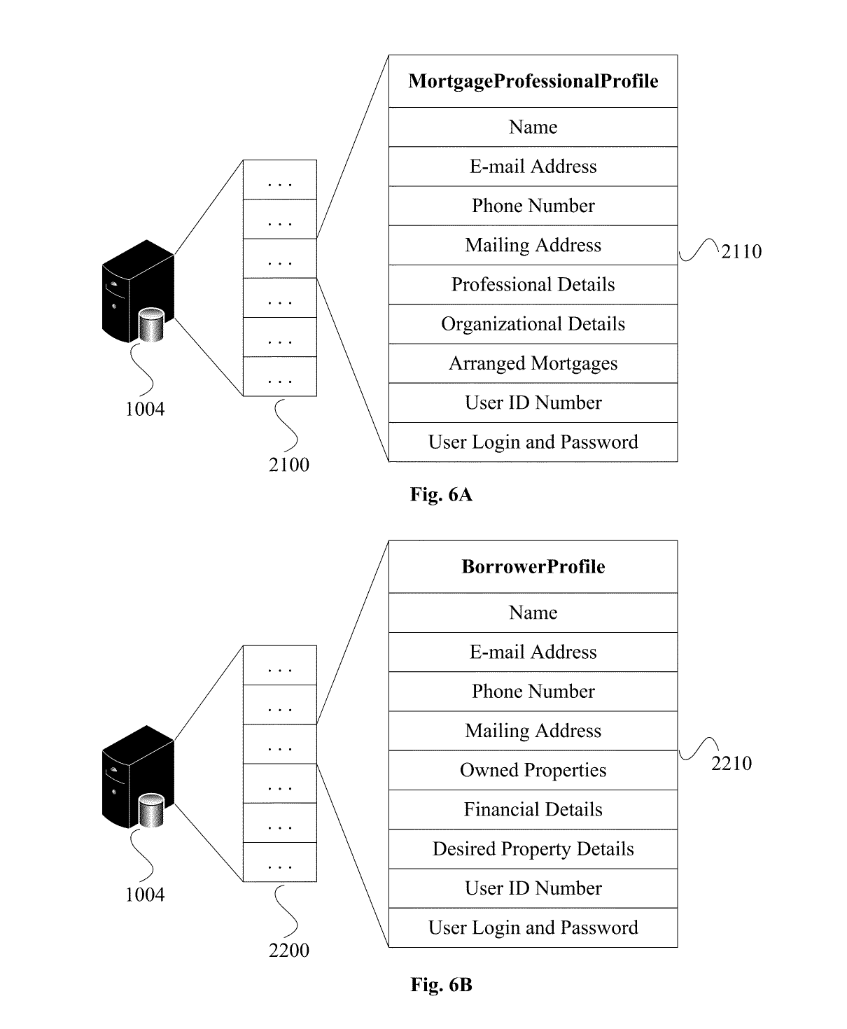

Mortgage professional and borrower user profiles established during registration are stored by the WLH system in a database. FIG. 6A illustrates one embodiment of a database configuration and structure for storing mortgage professional profiles. Here, database 2100 is stored on server machine 1004. Each box of database 2100 indicates a separate profile for a mortgage professional. A sample MP profile 2110 is shown in an expanded view, illustrating various data objects and fields that comprise a mortgage professional profile, including the Name, E-mail Address, Phone Number, Mailing Address, Professional Details, Organizational Details, Arranged Mortgages, User ID Number, and User Login and Password. The Professional Details field may include licensing numbers and states of licensure, while the Organizational Details may include the current and former employers for the user. Arranged Mortgages is preferably a list or data object comprising data regarding mortgage transactions arranged by the MP, such as the addresses and dates relating to the properties. User ID Number may be a field used internally by the WLH system, and the User Login and Password stores the user's WLH access information. One or more of the above fields may be encrypted for more secure storage of the data. It will be understood that the fields and/or data objects of profiles 2110 may be stored in a different order, in different data configurations, or with other, not illustrated MP-related data.

Turning to the borrower side, FIG. 6B illustrates one embodiment of a database configuration and structure for storing borrower profiles. Similarly to FIG. 6A, database 2200 is stored on server machine 1004 (or a separate machine). Each box of database 2200 indicates a separate profile for a mortgage professional. A sample PB profile 2210 is shown in an expanded view, illustrating various data objects and fields that comprise a mortgage professional profile, including the Name, E-mail Address, Phone Number, Mailing Address, Owned Properties, Financial Details, Desired Property Details, User ID Number, and User Login and Password. Here, the Owned Property field may identify the properties owned by the user, such as by address or other identification method. Financial Details preferably lists the borrower's financial information, such as annual income, social security number, optionally a credit score, amount of liquid funds available for purchase, and other pertinent financial information. Desired Property Details preferably provides parameters, selected by the borrower user, for properties desired to be purchased by the user. User ID Number may be a field used internally by the WLH system, and the User Login and Password stores the user's WLH access information. As noted with reference to FIG. 6A, one or more of the above fields may be encrypted for more secure storage of the data. It will be understood that the fields and/or data objects of profiles 2210 may be stored in a different order, in different data configurations, or with other, not illustrated PB-related data.

In the preferred embodiment, after the mortgage professional registers and creates a profile, he or she now has access to the full suite of services offered by the system. In other embodiments, the system may offer services to professionals without registration, but for the full scope of available services the professionals are encouraged to register and create a profile. The purpose of creating a profile is at least three-fold for a mortgage professional. First, it enables the professional to advertise him or herself to prospective borrowers, by being accessible and searchable through the website. Second, it enables the professional to search and seek out prospective borrowers and/or properties for whom they may offer services, such as, for example, mortgage arrangement. Third, it enables the professional to update his or her profile via a simple, web-based interface, thereby saving significant amounts of time.

It should be noted that in the preferred embodiment, MP profiles are stored in a Search Engine Optimization (“SEO”) friendly format to facilitate the marketing benefits of the WLH system to mortgage professionals. To this end, MP profiles are preferably stored in accordance with a well-established standard for storing and identifying data, such as XML, with the MP profile data being open to indexing by search engines such as Google, Bing, and Yahoo. In this way, mortgage professionals may be discovered not only by prospective borrowers accessing the WLH system, but also by borrowers using widely available search engines.

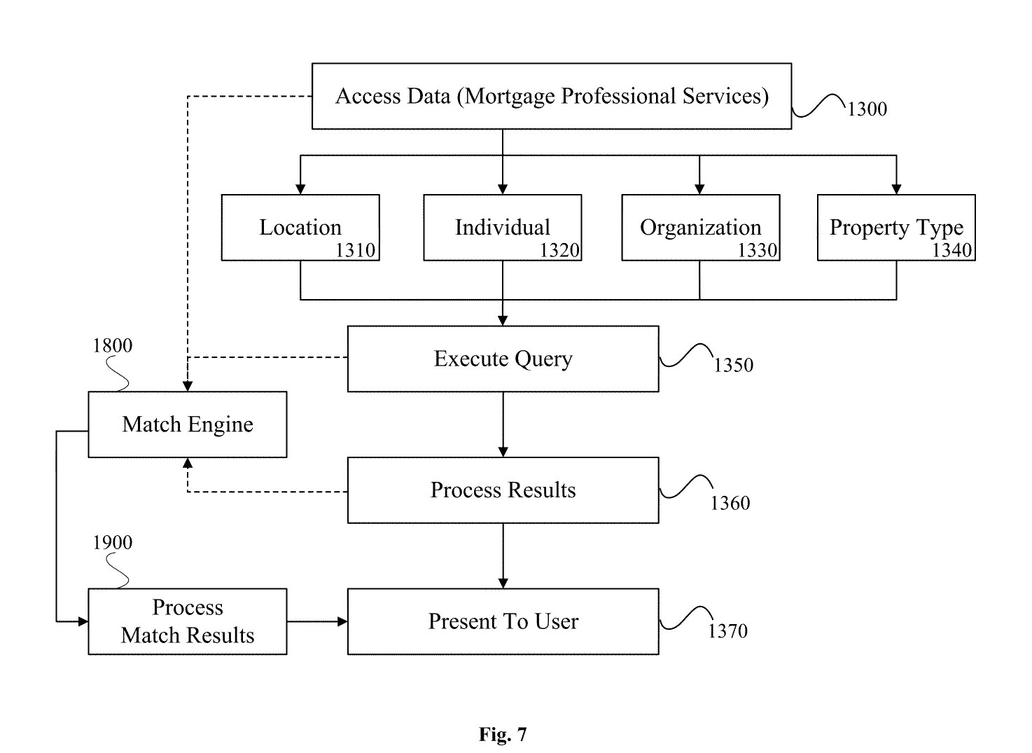

Turning to WLH services, FIG. 7 is a flowchart illustrating one embodiment of steps performed by the disclosed system in providing data access and matching services to mortgage professionals. At step 1300, the MP user has chosen to access data stored in the database, in order to, for example, search for prospective borrower clients. Arriving at step 1300 can occur via a variety of graphical user interfaces discussed above. After arriving at step 1300, the disclosed system may present the user with a number of different types of data, and ways of accessing that data. In one embodiment, the user may access data by location at 1310, data relating to individuals at 1320, data relating to organizations at 1330, and data relating to different property types at 1340.

At 1310, the mortgage professional may elect to browse or search for PBs by entering a specific address, zip code, or city. The disclosed system will provide appropriate interface portals to obtain the user's search and/or browsing parameters. At 1320, the mortgage professional may choose to find information relating to a particular individual, for example, by searching for a specific name, residence address, e-mail address, telephone, or social security number. The provided information may include the individual's mortgage and credit histories. In addition, or alternatively, at 1320 the website may provide information to the MP about another mortgage professional's activities. At 1330, the website may provide MP users with data relating to mortgages and other deals processed by a particular organization. At 1340, the website may allow a mortgage professional to search for closings, processed mortgages, and other related information, by property type. For example, a user may choose to search only for transactions or properties desired by PBs involving co-ops, and not condos or other property types. It will be understood that other search parameters may be employed by, and/or offered to MP users, together or instead of Location 1310, Individual 1320, Organization 1330, and Property Type 1340.

Once the mortgage professional user has selected the type of data to search, and entered parameters via an interface presented by the website at steps 1310, 1320, 1330, and/or 1340, the website passes the parameters to an appropriate backend software module, so that the system can execute a query in the mortgage services database at 1350 pursuant to the parameters entered by the user. Step 1350 is preferably performed by a dedicated database server as in FIGS. 1B or 1C, but in certain embodiments may be performed by a software and/or hardware module as part of an integrated solution, such as the configuration illustrated in FIG. 1A. At step 1360, the system, preferably at a database server, processes the results of the query and prepares them for presentation to the user. Step 1360 may include filtering of returned results, generation of a website or website component, formatting of the results for presentation to the user, or other processing steps. At step 1370, the disclosed system, preferably through the website, presents the processed query results to the user.

In addition, or as an alternative, to the location, individual, organization, and property type data searches identified as 1310-1340, the mortgage professional user may optionally take advantage of a match engine provided by the system disclosed herein. The purpose of the match engine is to match the mortgage professional with prospective borrowers based on the professional's profile, and/or entered search criteria. In FIG. 7, the execution of the Match Engine is illustrated as step 1800. The dashed lines pointing from Access Data step 1300, Execute Query step 1350, and Process Results step 1360, illustrate the flexibility of the presently disclosed system in general, and the Match Engine in particular. Specifically, the Match Engine is not a requirement of data access services provided to mortgage professionals, as they may browse and/or search for various data types outlined above without invoking the Match Engine. Preferably, the match engine may be invoked at various points in the data access process. For example, a user may request the system to execute the match engine from the basic Access Data interface indicated at step 1300. The system may also execute the match engine after Execute Query step 1350 and/or Process Results step 1360. Further, the system may execute the Match Engine automatically, without user input, as the user browses the website, presenting the match results at appropriate junctures, such as when other search results are presented.

In the preferred embodiment, if the Match Engine is executed from the basic MP access data interface, the system relies on the mortgage professional's profile to find matching borrowers. If the Match Engine is executed after the Execute Query step 1350, the system will run a matching algorithm that is in part based on the query parameters. If the Match Engine is executed after the Process Results step 1360, the system will run a matching algorithm on processed results, which may include more or less data than at the query stage, such as included metadata or converted results. After the Match Engine executes at 1800, the system proceeds to Process Match Results at 1900, which may include formatting the match results for presentation to the user, and presents the match results to the user at 1370. It will be understood that various parts of an MP profile may be used in the matching process, in combination with search criteria entered by the MP user at 1310-1340.

Turning to the borrower side of WLH, in the preferred embodiment, after a PB registers and creates a profile, he or she now has access to the appropriate services offered by the system. In the preferred embodiment, the system also offers certain services to borrowers without registration through the main website, but for the full scope of available services borrowers are encouraged to register and create a profile. By creating a profile, a borrower enables the disclosed system to offer services that are closely tailored to the user's parameters, and therefore more relevant to the user, saving the user's time and effort.

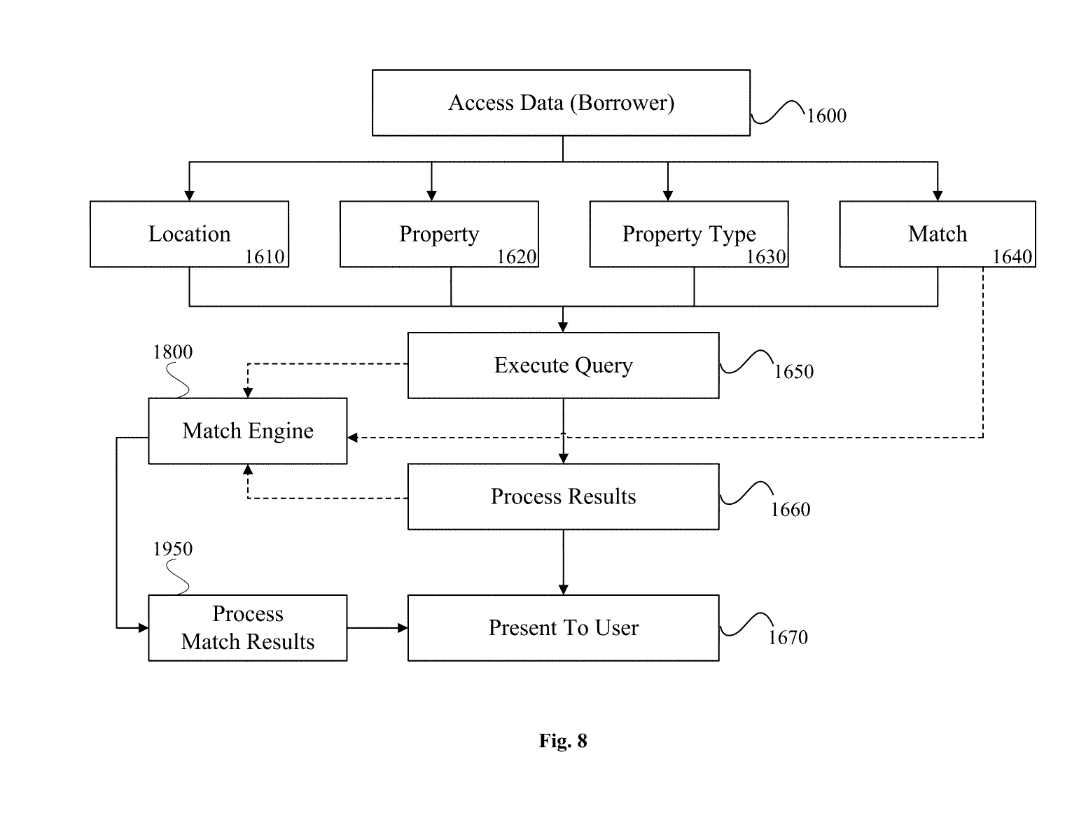

FIG. 8 is a flowchart illustrating one embodiment of a process performed by the disclosed system in providing data access and matching services to borrowers. In the preferred embodiment, the flowchart in FIG. 8 appears similar to the flowchart in FIG. 7, with several differences discussed herein. At step 1600, the borrower user has chosen to access data stored in the database. Arriving at step 1600 can occur via a variety of graphical user interfaces discussed above. After arriving at step 1600, the disclosed system may present the user with a number of different types of data, and ways of accessing that data. In one embodiment, the user may access data by location at 1610, data relating to a specific property or properties at 1620 (such as a specific property address), data relating to property types at 1630. In the preferred embodiment, the borrower user would use location, property, and property type searches 1610, 1620, and/or 1630 to locate a mortgage professional or organization corresponding to the entered search parameters. Alternatively, the user may request to be matched with a mortgage professional and/or a property at step 1640. Although both FIGS. 7 and 8 illustrate the optional availability of a match engine, in FIG. 8 the Match search option at step 1640 are listed on the same level as the location, property, and property type searches 1610-1630 to illustrate a more borrower-oriented approach of the borrower-side services of the currently disclosed system. In one embodiment, an option to get matching results for a borrowers is prominently displayed together with other services for registered users, making it easier for borrowers to find appropriate mortgage professionals.

At Location-based step 1610, the potential borrower may elect to browse or search for mortgage professionals by a geographic identifier such as a specific address (that may or may not include an apartment number), zip code, city, and/or state. The WLH system may also be configured to automatically fill in missing parameters in a supplied geographic identifier. For example, if the user supplies only a street address in the format “9999 Madison Avenue,” the WLH system may be configured to search through a database and complete the entered address with the city, state, and zip code, or may suggest alternatives if no matches were found. The disclosed system will provide appropriate interface portals to obtain the user's search and/or browsing parameters. At 1620, the mortgage professional may choose to find information relating to a particular property, for example, by searching for a specific address. At 1630, the website may provide users with lists of mortgage professionals based on the property type provided by the user. For example, certain mortgage brokers may specialize in obtaining mortgages for co-op apartments, and not for condos. At 1640, the website may allow a borrower to request a matching service based on parameters he or she will provide to the system, and/or based on his already existing profile. It will be understood that other search parameters may be offered to, and/or used by, the PB user in addition or in alternative to Location 1610, Property 1620, and Property Type 1630. For example, a PB user may elect to search for mortgage professionals by name, or by the name of their employer and/or organization.

One apparent difference between FIGS. 7 and 8 is that FIG. 8 includes the PB Match option 1640 in line, or on the same level, as search parameters 1610-1630, whereas FIG. 7 does not include a corresponding match option. The inclusion of Match option 1640 in FIG. 7 should not be construed as affecting, or somehow restricting, the capabilities of the PB and MP services relative to each other. Rather, as contemplated in the preferred embodiment, the “matching” service would be promptly offered to prospective borrower users together with other search options, to provide consumer-friendly functionality. On the other hand, mortgage professionals, are deemed to possess a greater knowledge of the mortgage services market, and may require more nuanced search and matching capabilities, and may be less reliant on a pre-configured “matching” option. Accordingly, a separate Match option does not appear in the preferred embodiment illustrated in FIG. 7. However, it will naturally be understood by one of ordinary skill in the art that the WLH system interface may be configured to provide identical functionality to both MP and PB users, in various combinations and options.

Once the borrower user has selected the type of data to search, and entered parameters via an interface presented by the website at steps 1610, 1620, 1630, and/or 1640, the website passes the parameters to an appropriate module, so that the system can execute a query in the borrower database at 1650 pursuant to the parameters entered by the user. Step 1650 is preferably performed by a dedicated database server as in FIG. 1B or 1C, but in certain embodiments may be performed by a software and/or hardware module as part of an integrated solution, such as the configuration illustrated in FIG. 1A. At step 1660, the system, preferably at a database server, processes the results of the query and prepares them for presentation to the user. Step 1660 may include filtering of returned results, generation of a website or website component, formatting of the results for presentation to the user, or other processing steps. At step 1670, the disclosed system, preferably through the website, presents the processed query results to the user.

In addition, or as an alternative, to the location, property, and property type data searches identified as 1360-1630, the borrower user may optionally take advantage of a match engine provided by the system disclosed herein. The purpose of the match engine is to match the prospective borrower with a mortgage professional based on the borrower's profile, or entered search criteria. In FIG. 8, the execution of the Match Engine is illustrated as step 1800. The dashed lines pointing from Access Data step 1600, Execute Query step 1650, and Process Results step 1660, illustrate the flexibility of the presently disclosed system in general, and the Match Engine in particular. Specifically, the Match Engine is not a requirement of data access services provided to borrowers, as they may browse and/or search for various data types outlined above. In addition, the match engine may be invoked at various points in the data access process. For example, the system may execute the match engine after user selection at Match step 1640, Execute Query step 1650 and/or Process Results step 1660. Further, although not shown in FIG. 8, a user may request the system to execute the match engine from the basic Access Data interface indicated at step 1600. As with mortgage professional services, the system may execute the Match Engine automatically for borrower users, without user input, as the user browses the website, presenting the match results at appropriate junctures, such as when other search results are presented.

In the preferred embodiment, if the Match Engine is executed after being selected in Match step 1640, the system relies on the borrower's profile and/or entered search criteria to find matching borrowers. If the Match Engine is executed after the Execute Query step 1650, the system will run a matching algorithm on the query parameters. If the Match Engine is executed after the Process Results step 1660, the system will run a matching algorithm on processed results, which may include more or less data than at the query stage, such as included metadata or converted results. After the Match Engine executes at 1800, the system proceeds to Process Match Results at 1950, which may include formatting the match results for presentation to the user, and presents the match results to the user at 1670.

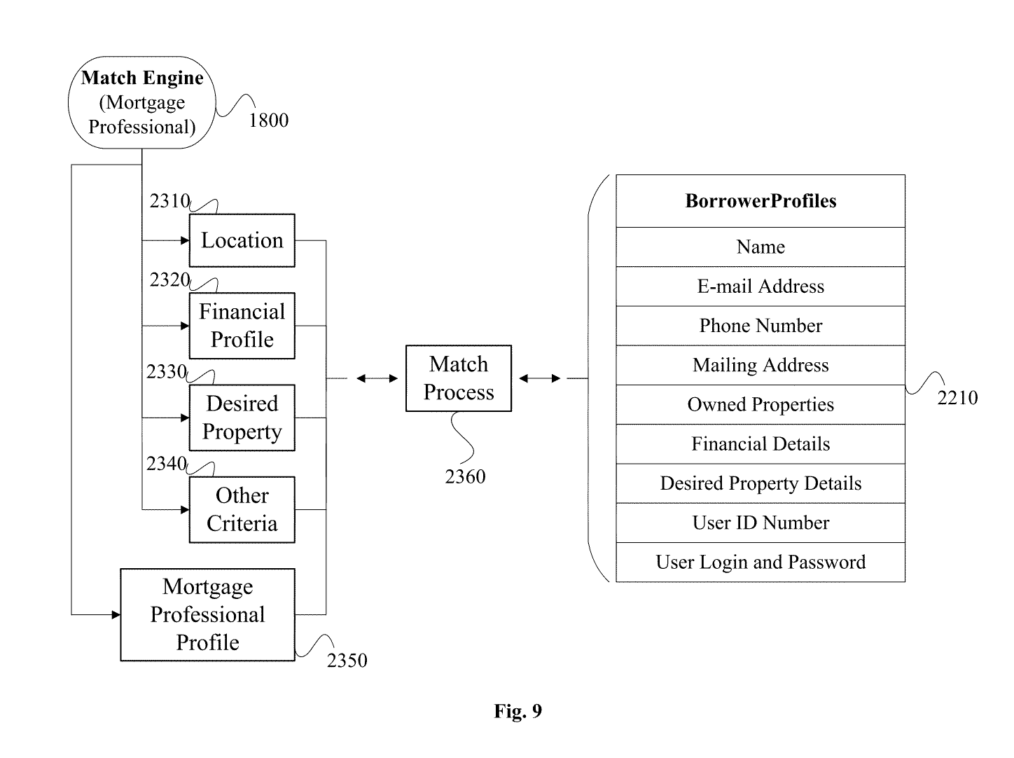

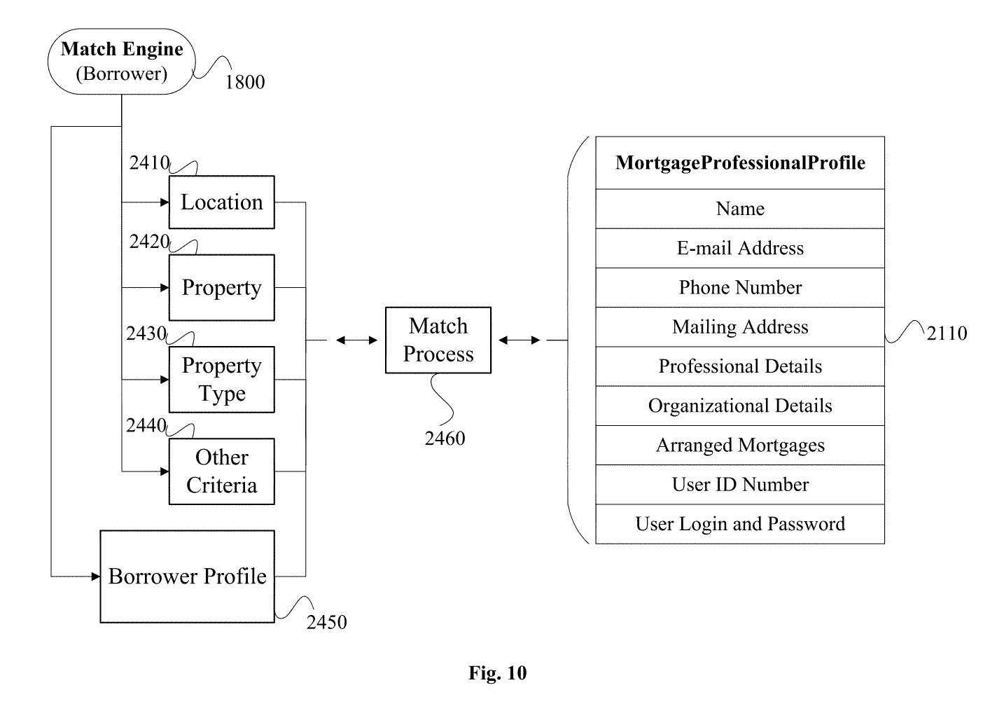

Turning to Match Engine 1800 appearing in FIGS. 7 and 8, a more specific description of the engine appears in FIGS. 9 and 10. Described generally, the match engine compares certain search and profile parameters with data stored in the database, to find appropriate matches for the user. Thus, the match engine helps connect prospective borrowers with mortgage professionals appropriate for the borrower, and vice versa. In FIG. 9, which illustrates one embodiment of the match engine used to match MPs with PBs, when activated, Match Engine 1800 can use match parameters input by the MP user, such as Location 2310, Financial Profile 2320, Desired Property 2330, and Other Criteria 2340 together with the Mortgage Professional's Profile 2350, to find matching data in the database. Matching parameters 2310-2340 from FIG. 9 supplied by the MP user to the match engine may be the same as search criteria 1310-1340 from FIG. 7, or they may be different parameters. As noted earlier, the WLH system is agile by design, offering significant configurability. In some embodiments, for example, the “data access” or search interface available to MPs may offer searches for prospective borrowers by name, whereas the matching interface will not. It will be understood that various combinations of search and/or matching parameters may be implemented in accordance with the present invention. Further, consistent with FIGS. 7 and 8, the match engine may combine search criteria with a mortgage professional's profile in Match Process 2360. In the alternative, the match engine may rely on discrete pieces of information to run the match, such as only the entered location, or only a data field from the mortgage professional's profile.

When Match Engine 1800 has determined which data will be used as the match input, it executes Match Process 2360, which compares the inputs provided by mortgage professionals and their profiles against fields and data objects of borrower profiles 2210. For example, if a mortgage professional requests a match by location, and enters a zip code, Match Process 2360 will compare the zip code against the Mailing Address and/or Desired Property Details of borrower profile 2210. In another example, where the match request is based solely on a mortgage professional's profile 2350, the Match Process 2360 may run a match using a field in Mortgage Professional Profile 2350, such as Arranged Mortgages, to find borrowers in the same financial situation as the mortgage professional's previous clients based on the Financial Details field of profile 2210. One of ordinary skill in the art will recognize that the match engine may be configured to use various fields and/or combinations of fields from the mortgage professional profile as input data. Once the match results are obtained, the results are processed for presentation to the user as indicated by steps 1900 and 1370 of FIG. 7.

Turning to the borrower-side match engine illustrated in FIG. 10, the matching process is similar to the mortgage professional embodiment illustrated in FIG. 9. In FIG. 10, when activated, Match Engine 1800 can use match criteria input by the user, such as Location 2410, Property 2420, Property Type 2430, and Other Criteria 2440 together with the Borrower's Profile 2350, to find matching data in the database. Consistent with FIGS. 7 and 8, the match engine may combine search and/or match criteria with a borrower's profile in Match Process 2460. In the alternative, the match engine may rely on discrete pieces of information to run the match, such as only the entered location, or only a data field from the borrower's profile.

When Match Engine 1800 has determined which data will be used as the match input, it executes Match Process 2460, which compares the inputs provided by borrowers and their profiles against fields and data objects of mortgage professional profiles 2110. For example, if a mortgage professional requests a match by a property type, and selects ‘condominium,’ Match Process 2460 will compare that property type against arranged mortgages in mortgage professional's profile 2110. In another example, where the match request is based solely on a borrower's profile 2450, the Match Process 2460 may run a match using a field in Borrower Profile 2450, such as Financial Information, to find borrowers in the same financial situation as the mortgage professional's previous clients as identified in the Arranged Mortgages field of profile 2110. One of ordinary skill in the art will recognize that the match engine may be configured to use various fields and/or combinations of fields from the borrower profile as input data. Once the match results are obtained, the results are processed for presentation to the user as indicated by steps 1950 and 1670 of FIG. 8.

It will be understood by one of ordinary skill in the art that although FIGS. 7-10 refer to the Match Engine with a single reference numeral 1800, in practice the match engines for the borrower and mortgage professional sides of WLH will have slightly different implementations, although they may draw on the same code base as it relates to the matching of data objects and database fields. In the preferred embodiment, the difference between the borrower and mortgage professional match engine modules is mainly due to the different parameters being matched depending on whether the borrower or mortgage professional user requested a matching operation, since the two types of users may request, and the system may be configured to provide, matches based on different criteria types. In other embodiments, the MP and PB match engines may have virtually no differences or they may be vastly different implementations.

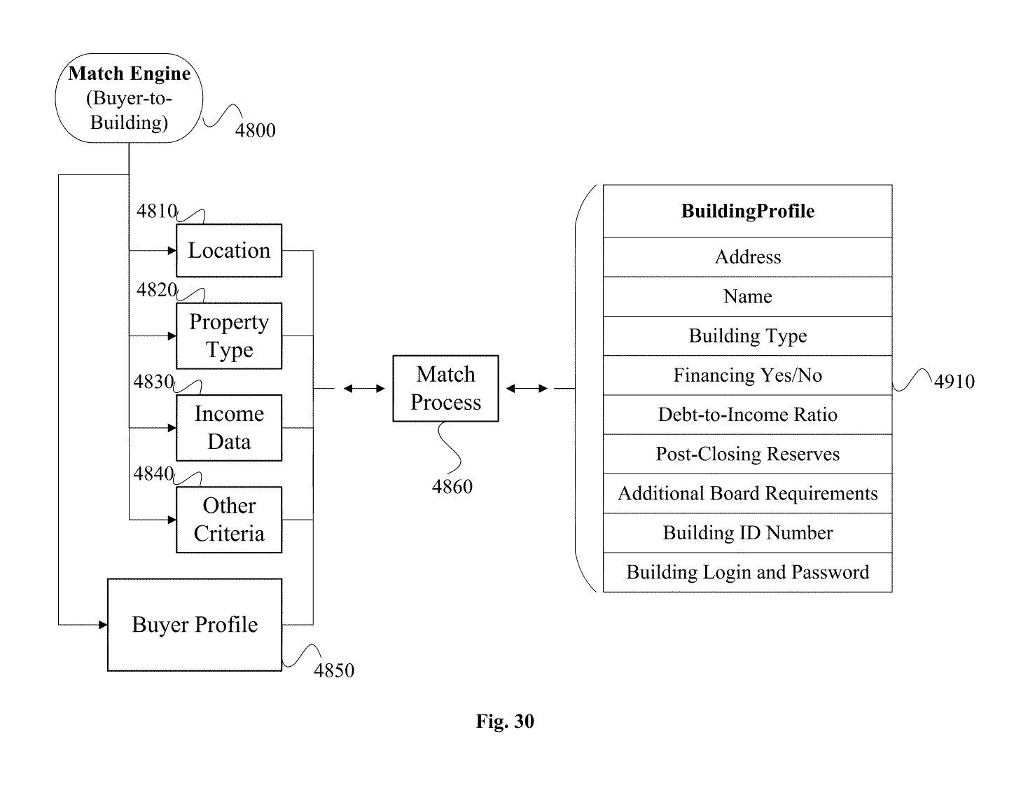

In another embodiment of the presently disclosed system, the WLH interface and back end may be configured to provide searching and/or matching services to prospective apartment buyers searching for buildings where the buyers are likely to satisfy requirements established by the building's board of directors. One example of this embodiment is illustrated in FIG. 30. Here, similarly to embodiments described above, the matching is based on pre-configured building profiles stored in the WLH database. BuildingProfile 4910 from FIG. 30 illustrates one example of a building profile, comprising entries for the building's address, name, building type (such as, for example, condo, co-op, condop, or condotel), whether financing is allowed (yes/no), the buyer's debt-to-income ratio permitted by the board, buyer's post-closing reserves required by the board, and other board requirements. In this example, the profile also contains a building ID number (which may be used for internal WLH processes such as searching, matching, and updates), and a building login and password that may be used by representatives of the building to edit and update the profile.

One of ordinary skill in the art will recognize that the graphical interface by which users may access the buyer-to-building match engine may be based on, or similar to, the interfaces disclosed with respect to the borrower and mortgage professional match engine embodiments, in FIGS. 3A-B, 7-8, 11, 27, 29, accompanying text, and other interfaces.

Turning to the buyer-to-building match engine illustrated in FIG. 30, when activated, Match Engine 4800 can use match criteria input by the user, such as Location 4810, Property Type 4820, Buyer's Income Data 4830, and Other Criteria 4840 together with the Buyer's Profile 4850 (which may be established using similar techniques as the other profiles described herein), to find matching buildings in the database. The match engine may also combine search and/or match criteria with a buyer's profile in Match Process 2460. In the alternative, the match engine may rely on discrete pieces of information to run the match, such as only the entered location, or only a data field from the buyer's profile.

When Match Engine 4800 has determined which data will be used as the match input, it executes Match Process 4860, which compares the inputs provided by buyers and their profiles against fields and data objects of building profiles 4910. For example, if a buyer requests a match by a property type, and selects ‘condominium,’ Match Process 4860 will compare that property type against building types in building profiles 4910. In another example, where the match request is based solely on a buyer's profile 4850, the Match Process 4860 may run a match using a field in Buyer Profile 4850, such as the buyer's income and savings data, to find buildings that accept buyers in the same or similar financial situations as the buyer, based, for example, on the Debt-to-Income Ratio and Post-Closing Reserve fields from building profiles 4910. Other Criteria 4840, may include special building requirements, such as, for example, minimum permitted down payments, which could be compared with BuildingProfile 4910 Additional Board Requirements fields. One of ordinary skill in the art will recognize that the match engine may be configured to use various fields and/or combinations of fields from the buyer profile as input data. Once the match results are obtained, the results are processed for presentation to the user, similarly to the examples illustrated in FIGS. 7 and 8.

An additional feature that may be optionally implemented in the above-described embodiments is an influence, or reputational, score for mortgage professionals. One of the main purposes of the influence score is to establish a trust level between borrower users and mortgage professionals listed on the WLH site. The score may be computed in a variety of ways, including ratings of the MP provided by WLH users, the number and quality of social media posts and number of “likes” and/or “shares” (both by the MP and likes of the MP and his or her content by other users), the number of times an MPs profile was viewed by users, searches for the MP, and reviews of the MP prepared by users. One of ordinary skill in the art will recognize that various interfaces for receiving user input for the above score components may be implemented through the website. The influence score is preferably stored in mortgage professional profiles, such as the ones illustrated and described in FIGS. 6A, 10, and accompanying text. A MP's influence score may then be used by potential borrowers when searching and/or matching for an appropriate mortgage professional. For example, potential borrowers may choose to limit their search results to MPs with a score above a certain threshold, providing greater confidence in their prospective MP contacts.

### User Interface

Turning to WLH's user interface, FIGS. 11-28 illustrate one embodiment of a website constructed to provide some of the services disclosed herein.

FIG. 11 is a screenshot of one embodiment of the homepage of the website interface for the disclosed system. The WLH homepage in FIG. 11 introduces the user to WLH, and is viewable by both borrower and mortgage professional users. The top of the page includes the WHO LENDS HERE logo, and Search, How It Works, and Mortgage Professionals links that appear at the top of every page in this embodiment of the website. Search link 2520 enables users to search for data, such as property addresses, stored in the WLH database. How It Works link 2530 takes users to a page describing the WLH system, and Mortgage Professionals link 2540 transfers the user to a section of the WLH site dedicated to mortgage professionals. In this embodiment, the homepage also provides a search box 2510 for potential borrowers and other types of users such as real estate brokers, mortgage brokers, transactional attorneys, management agents, advertisers, and/or recruiters. The borrower is invited to enter a property address or a professional's name, and to press the search button located to the right of the search box.

If the user follows the Mortgage Professionals link 2540, the resulting page is illustrated in FIG. 12, which is the Mortgage Professionals introductory screen. Here, MPs are invited to register and create their profile, or to sign in via interface 2610.

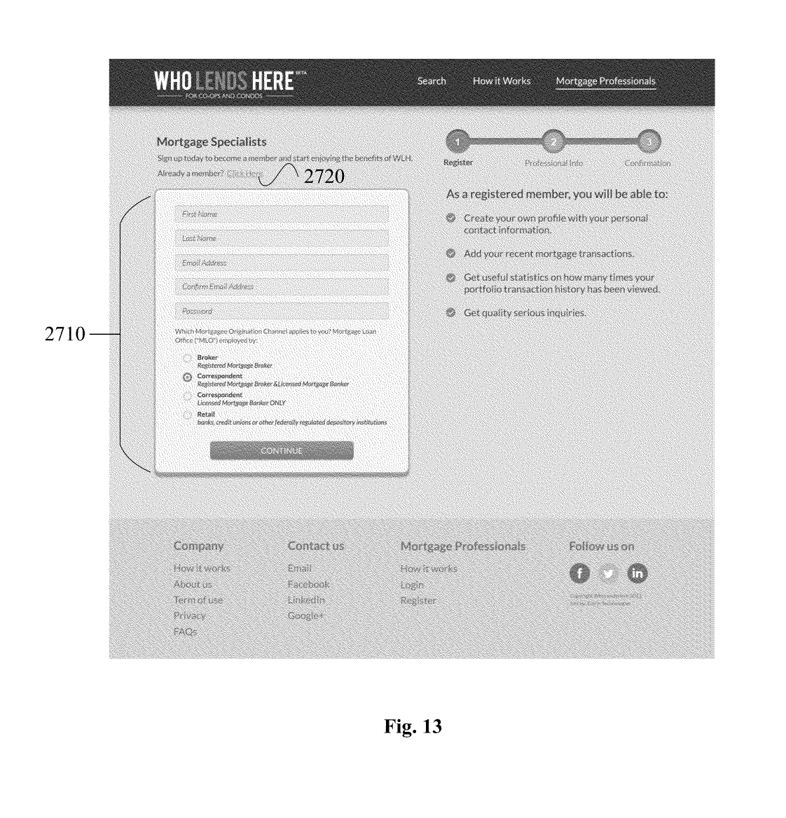

If the user follows the GET STARTED link 2620, the resulting page is illustrated in FIG. 13, which is a screenshot of an initial registration webpage for mortgage professionals in the illustrated embodiment of the disclosed system. Here, MP users are offered to complete the first step of the registration process, by entering their First Name, Last Name, Email Address, and Password in website portion 2710. The MP user is also invited, and in the illustrated embodiment required, to identify him or herself as a registered mortgage broker under heading Broker, registered mortgage broker and licensed mortgage banker under heading Correspondent, a licensed mortgage banker only under heading Correspondent, and banks, credit unions or other federal depository institutions under the heading Retail. If a mortgage professional has already registered, they are invited to log in by following link 2720.

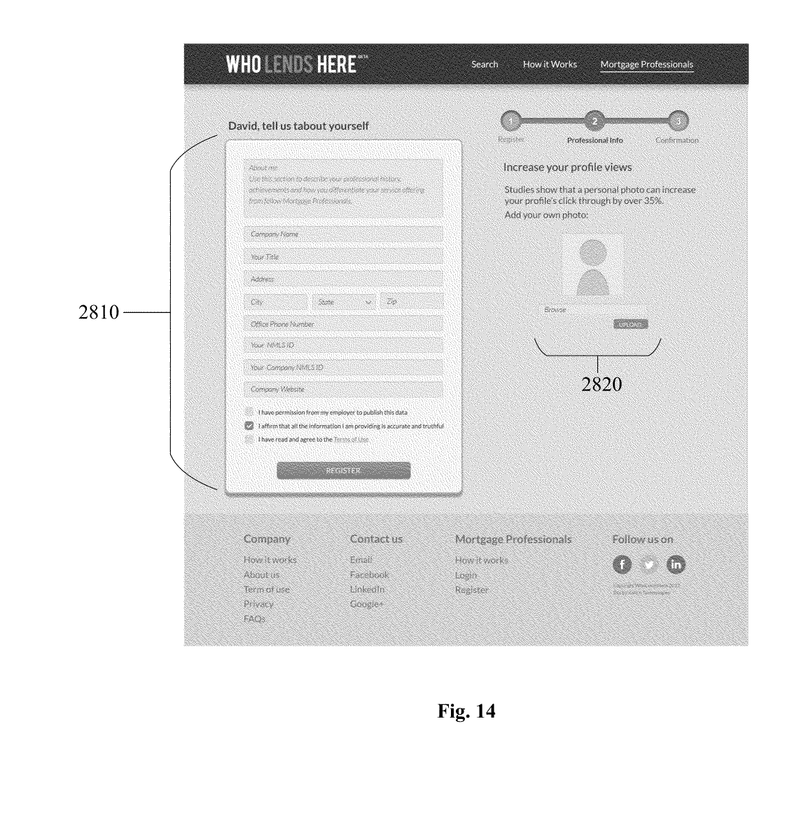

When the user activates the CONTINUE button from FIG. 13, the WLH system presents the webpage illustrated in FIG. 14, which is a screenshot of one embodiment of step two in the MP registration process. In FIG. 14, the user is invited to provide a description of his or her professional history and achievements, the company name, title, address, office phone number, his or her NMLS number and/or his or her employer's NMLS number, and the company website. This information is entered by the user in website portion 2810. In addition, the website invites the user to upload his or her picture through interface 2820. In the preferred embodiment, the MP user is also requested to confirm that he or she owns and/or has permission from his or her employer to publish the entered data, to affirm that all of the provided information is accurate and truthful, and to acknowledge and agree to the terms of use by checking off appropriate checkboxes.

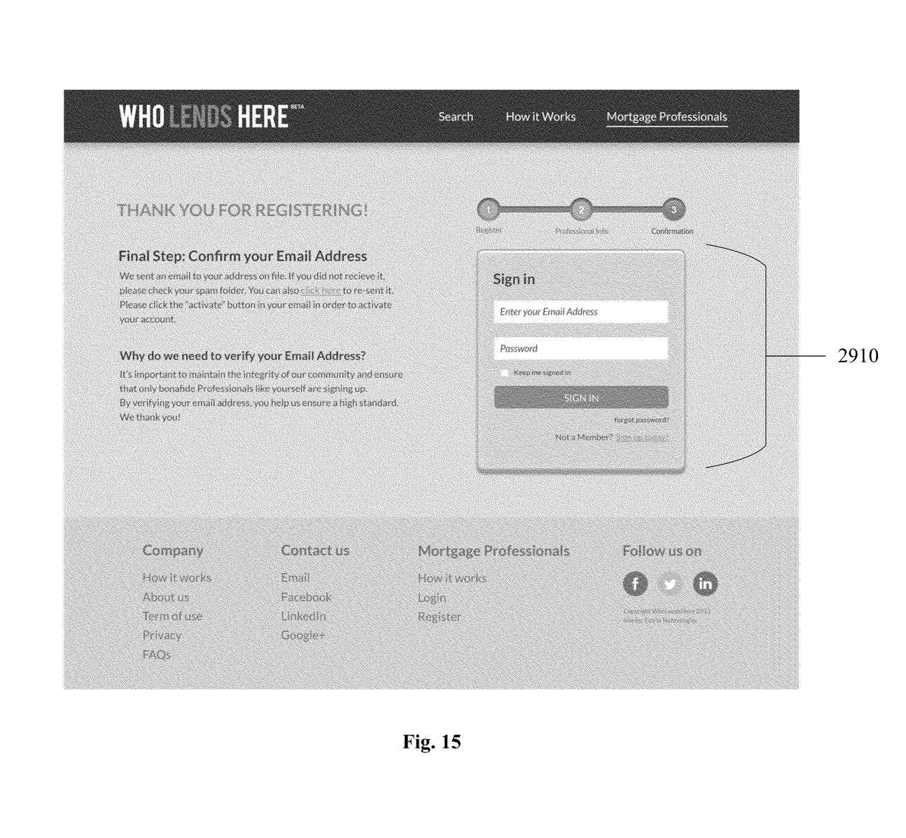

After following the REGISTER link in FIG. 14, the user is presented with the webpage illustrated in FIG. 15, which is a screenshot of one embodiment of the third registration step for mortgage professionals. Here the user is informed that his or her registration is complete, asked to confirm his or her email address, and invited to sign into the system through interface 2910, by providing an email address and password.

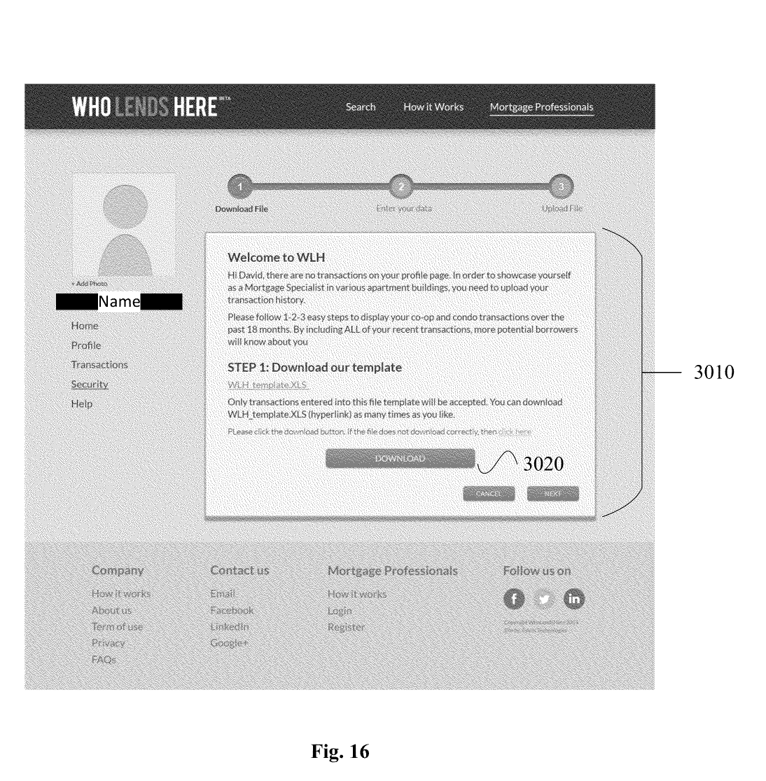

After signing into the WLH system, the mortgage professional user is offered to upload all of his or her recently handled mortgage transactions, as illustrated in FIG. 16. Here, the user is first offered to download a template file by following DOWNLOAD link 3020. The template file is preferably a Microsoft Excel formatted file that allows the user to enter his or her transactions in a format that will be understood by the WLH system. To proceed with the upload, the user is invited to follow the NEXT link in webpage portion 3010.

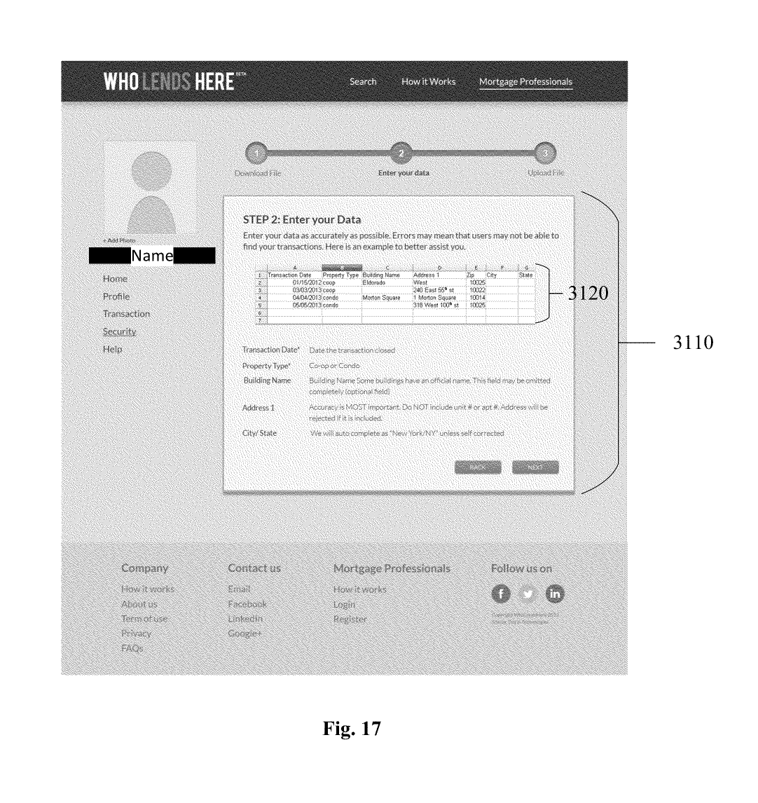

Next, the WLH website presents the MP user with step two of the transaction upload process, illustrated in FIG. 17. Here, the user is instructed on the proper way of entering transaction data into the template spreadsheet as described in website portion 3110, and provided examples of entered transactions in screenshot 3120. The user is then invited to follow the NEXT link at the bottom of webpage portion 3110.

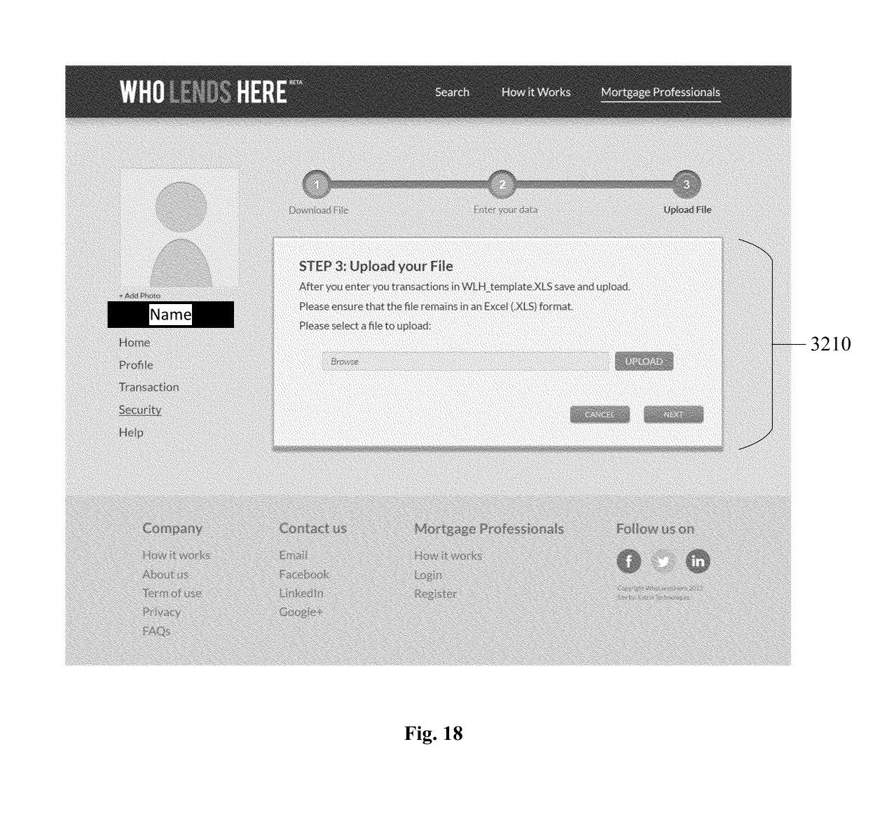

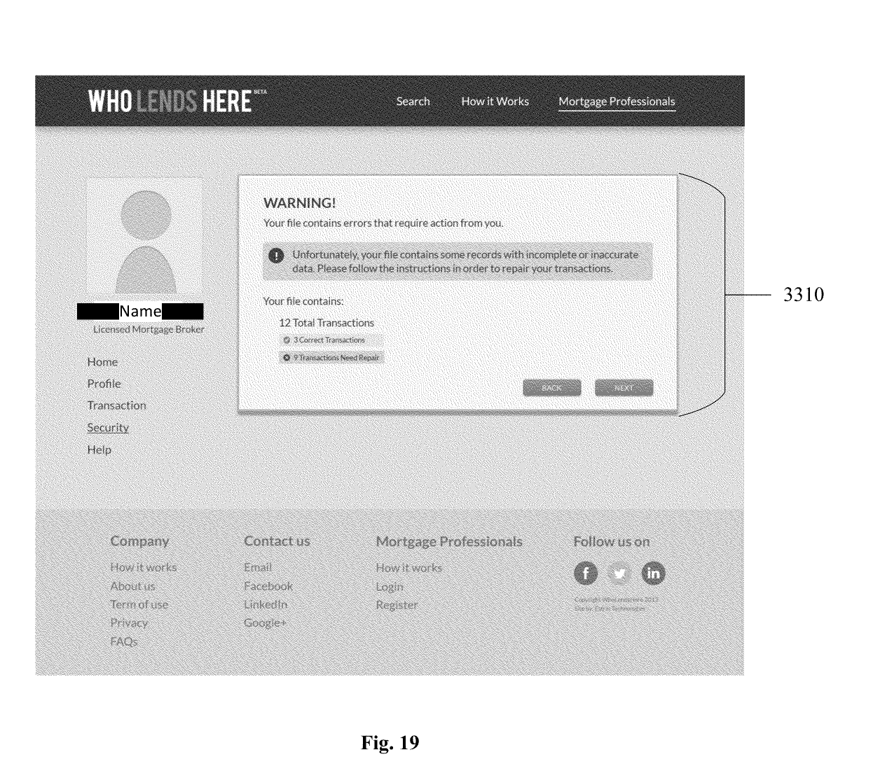

In FIG. 18, the user is invited to upload a template file populated with the user's mortgage transaction details, through interface 3210. After the user hits the UPLOAD link, the WLH system analyzes the uploaded file, and provides the user with its analysis, as illustrated in FIG. 19. Here, the WLH website notifies the user in webpage portion 3310 that some of the uploaded records were incomplete or inaccurate, and notes that of the 12 total transactions contained in the uploaded file, three are correct and nine need repair.

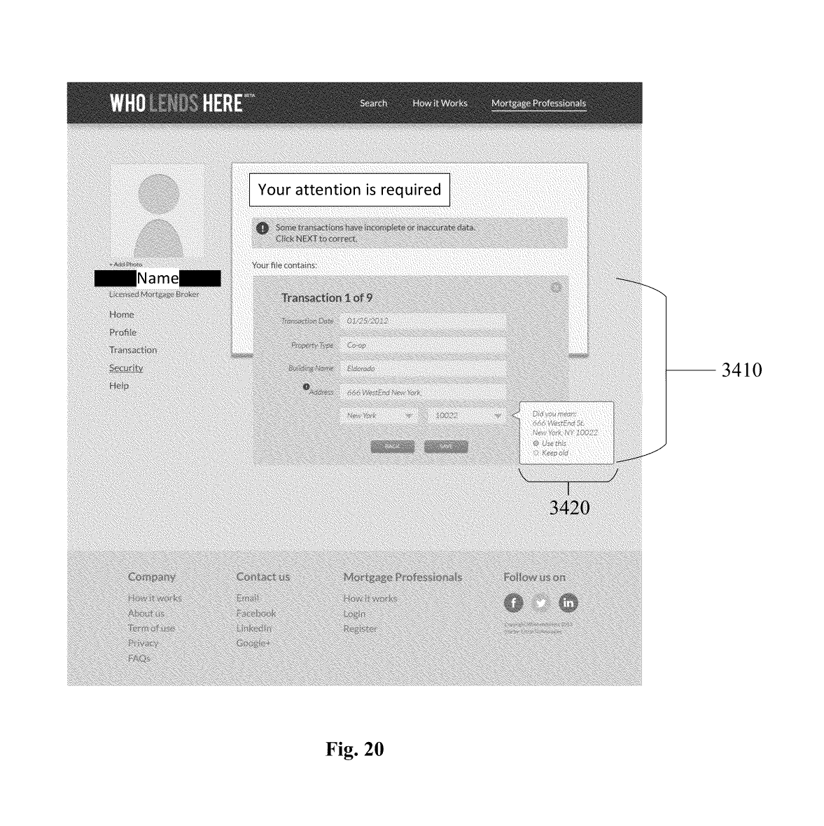

After the user follows the NEXT link, the WLH site presents him or her with an interface through which the user can repair each transaction determined to contain incomplete or inaccurate data, as illustrated in FIG. 20. Here, a pop-up box 3410 shows transaction one of nine, and notes that the provided address does not satisfy the system's acceptability criteria. Symptoms of corresponding errors may include an improperly entered address, such as an address entered without a street name, or in some embodiments of the system, the entered address may not exist in real life, as verified by the WLH system by connecting to an address database such as the one provided by the U.S. Postal Service. In FIG. 20, the WLH site presents the users with a suggested correction to the entered address in pop-up 3420, offering the user an opportunity to use the suggested address, or to keep it as entered, and to save the transaction record.

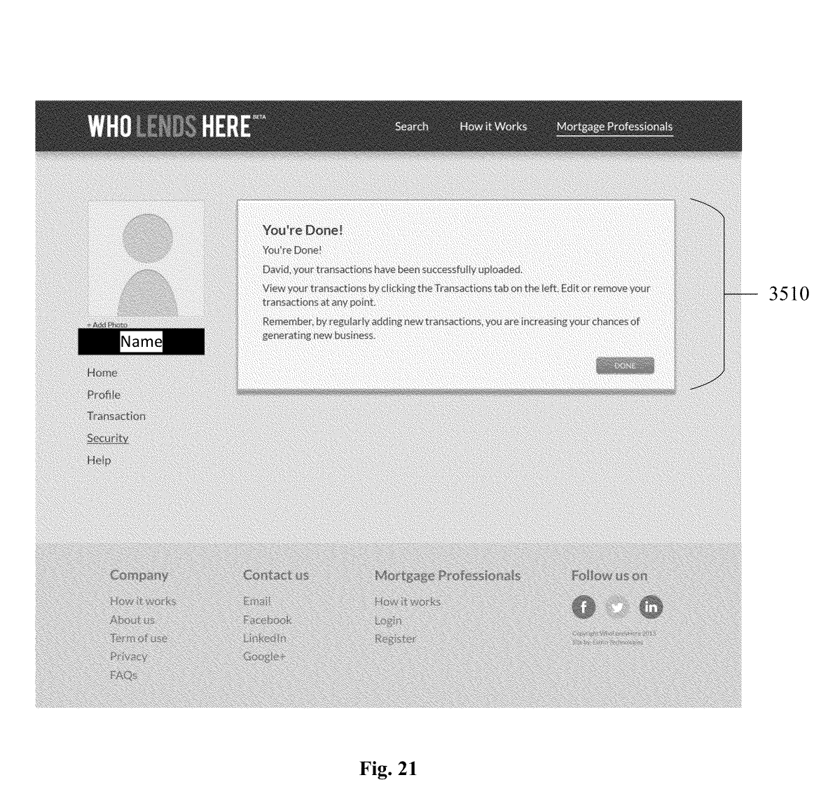

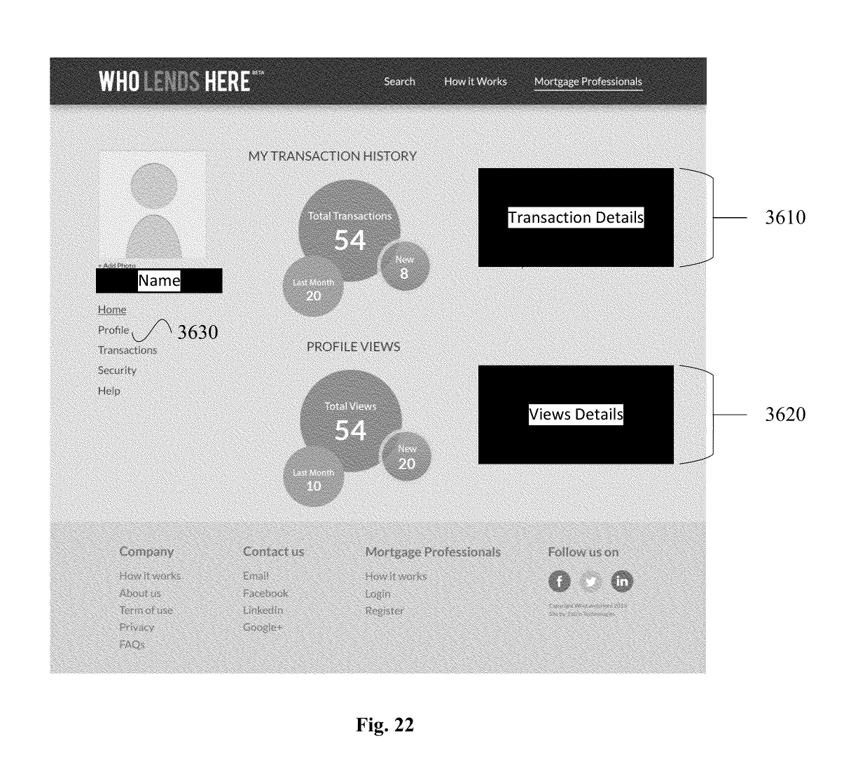

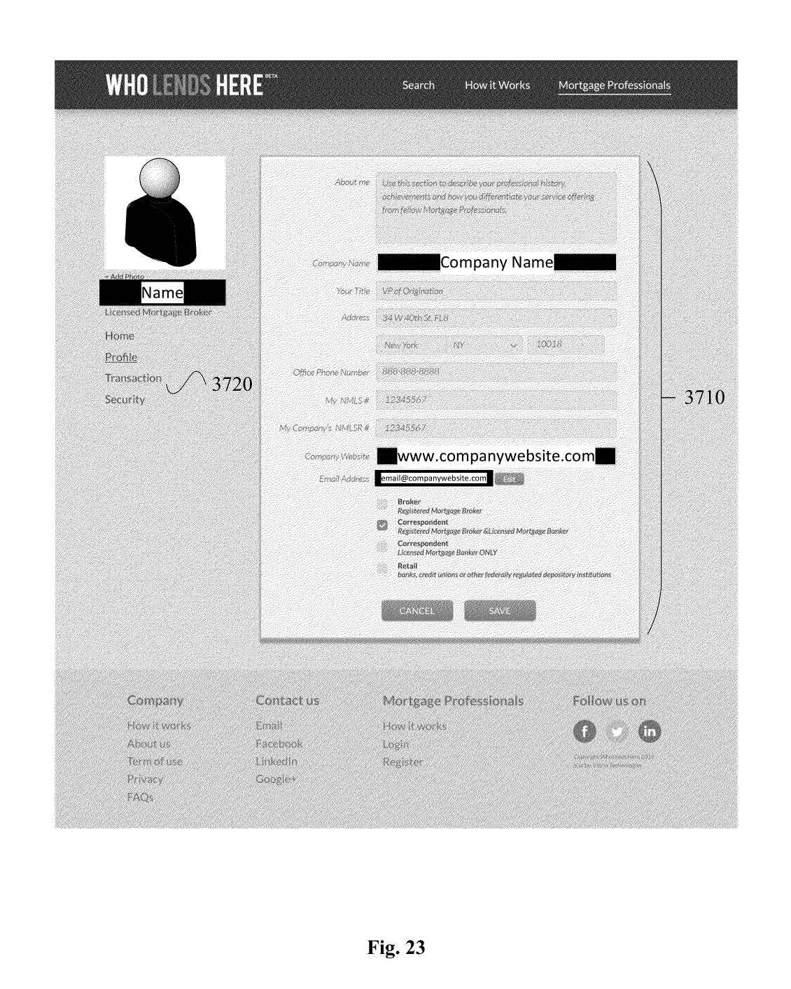

After the user updates the presented transaction records, the WLH system presents him or her with a webpage noting the successful upload of the user's transactions, as illustrated in FIG. 21. When the user follows the DONE link in website portion 3510, he or she is taken to the profile dashboard, illustrated in FIG. 22. In the profile dashboard embodiment illustrated in FIG. 22, the user is greeted with a snapshot of some statistics relating to transactions uploaded by the user, including transaction details 3610, and views of the user's profile, including details of the views 3620. If the user follows Profile link 3630, the WLH system presents him or her with an opportunity to review and edit profile details as illustrated in FIG. 23.

In the embodiment illustrated in FIG. 23, the user is able to review his or her profile, and edit it through interface 3710. Here, the user may edit the profile description, the company name, title, address, office phone number, the user's and company's NMLS numbers, website, and email addresses. The user may also edit his or her selection of user type, which he or she may have selected during registration. In the preferred embodiment, the user may elect to register as a registered mortgage broker, a registered mortgage broker and licensed mortgage banker, a licensed mortgage banker only, or as a bank, credit union, or other federally regulated depository institution.

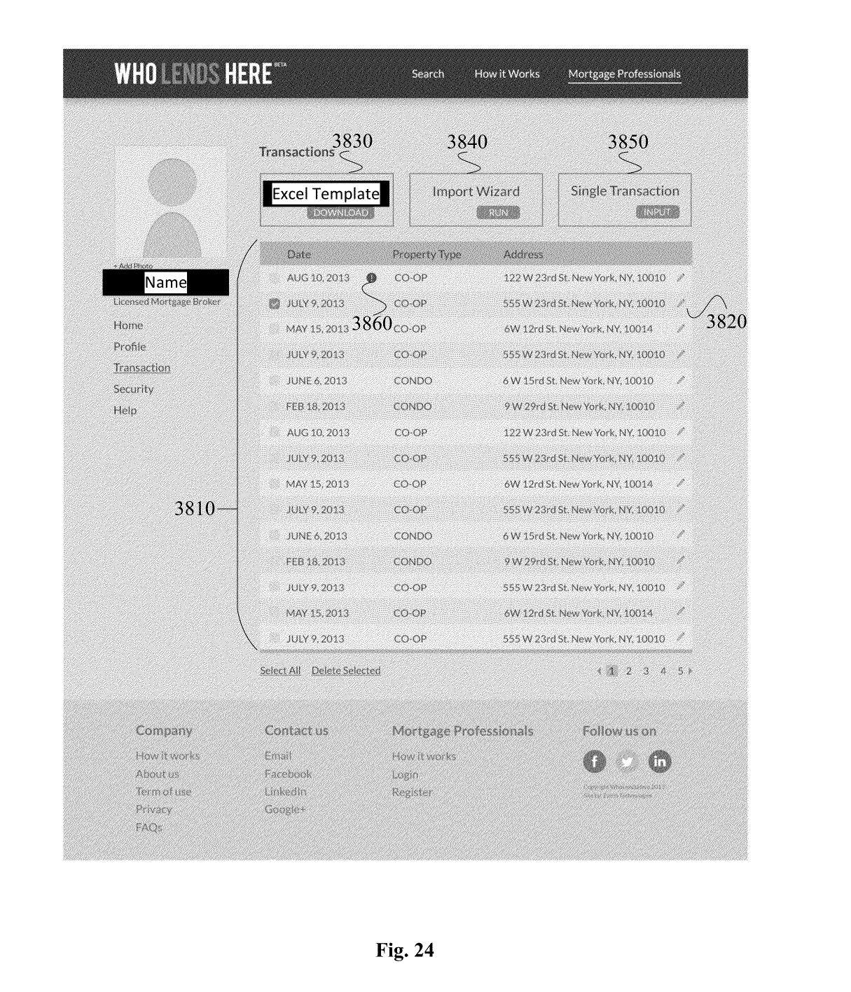

If the user follows Transaction link 3720, the WLH system presents him or her with an opportunity to review and edit details of mortgage transactions entered by the user, as illustrated in FIG. 24. In this embodiment, the user is presented with transaction list 3810, and ‘edit’ links 3820 to the right of every listed transaction. The user is also invited to download the excel transaction template at 3830, to run the import wizard at 3840, or input a single transaction at 3850. In the example illustrated here, one of the uploaded transactions contains an error, of which the WLH system notifies the user by displaying error indicator 3860. If the user fixes the erroneous entry by following ‘edit’ link 3820 or error indicator 3860, the WLH website clears the error indicator.

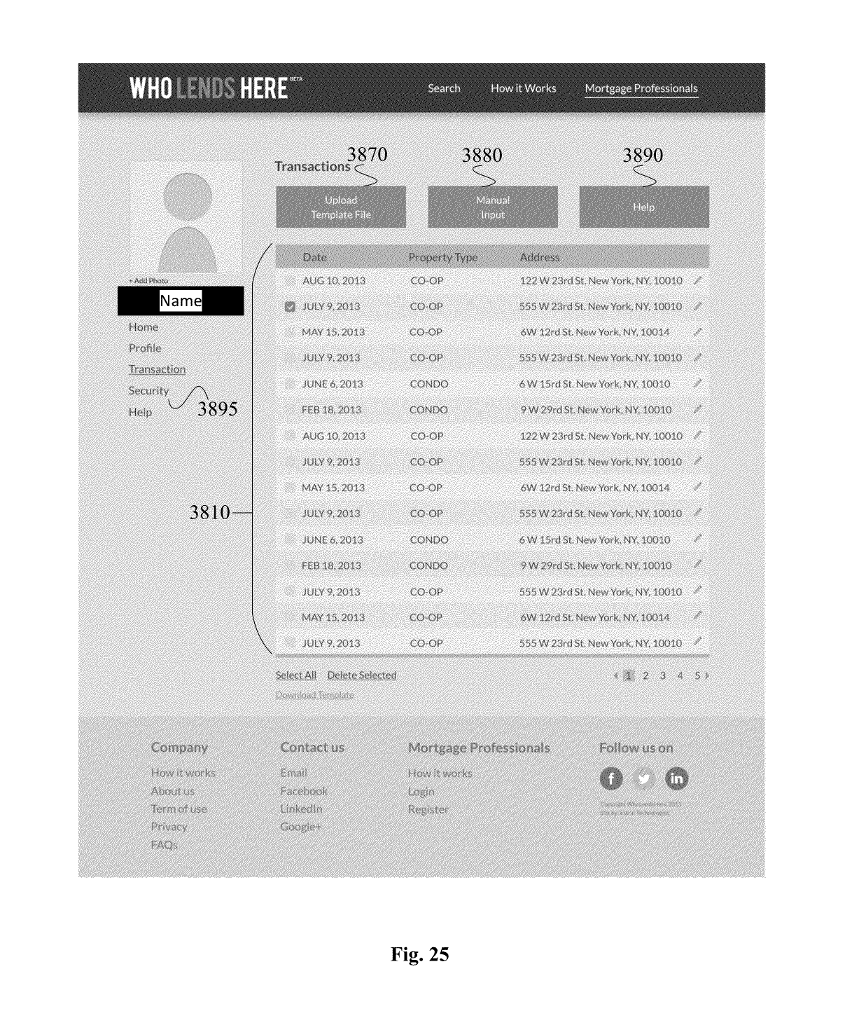

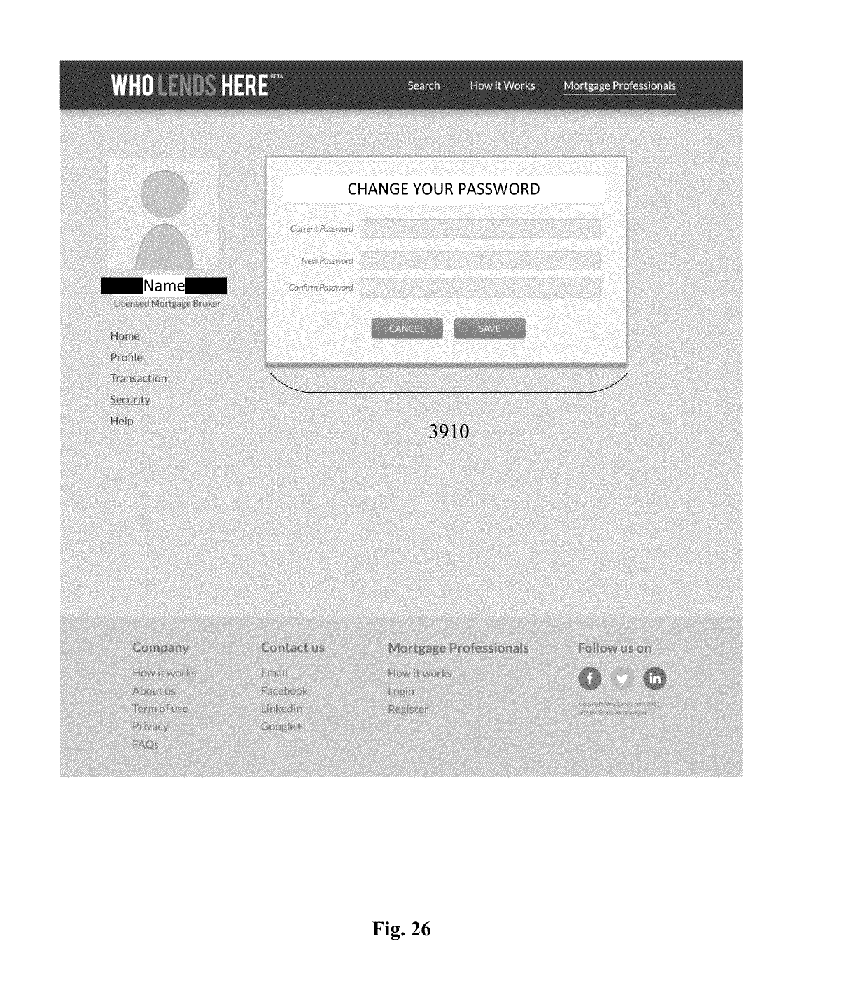

FIG. 25 shows an alternative embodiment of the transaction listing screen, showing a similar mortgage transaction listing 3810, but without the error indicator 3860. Here, the user is invited to Upload Template File at link 3870, provide Manual Input at link 3880, and obtain Help at link 3890. If the user follows Security link 3895, the WLH system presents the user with the webpage illustrated in FIG. 26, which invites the user to change his or her password through interface 3910.

Turning to the borrower-side features of the website embodiment illustrated in FIGS. 11-29, FIG. 27 is a webpage showing the results of a borrower's search for an address 4010 via the homepage shown in FIG. 11. Here, the borrower entered “999 E 52nd St., New York, N.Y. 10022” into the search box, and the WLH system returned the results 4020, 4030, 4040, and 4050. Results 4020, 4030, 4040, and 4050 are the names and brief descriptions of mortgage professionals that have handled mortgage transactions at 999 E 52nd St., with links to their detailed profiles.

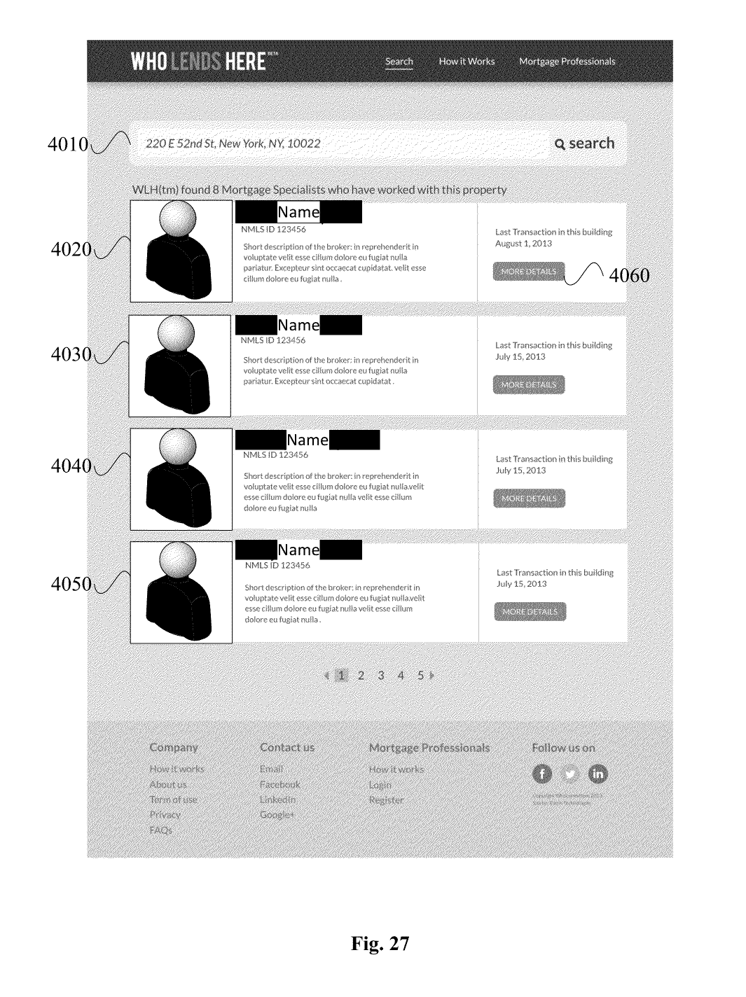

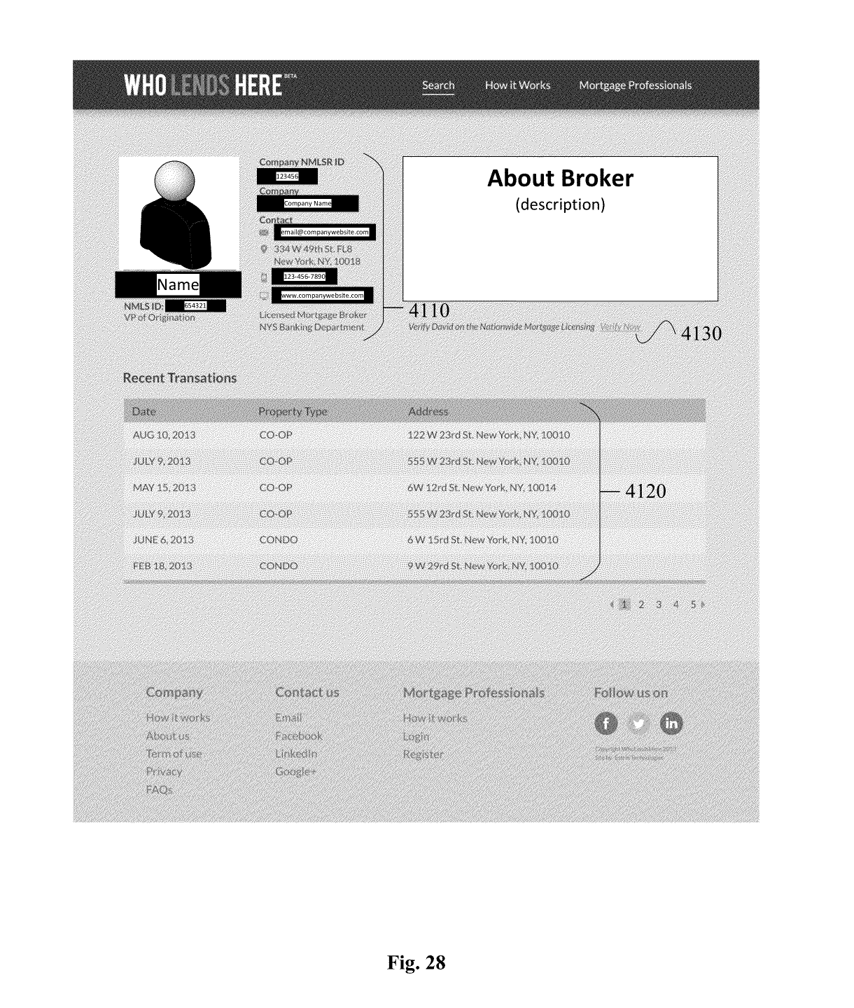

If the user follows the MORE DETAILS link 4060, the WLH system presents the user with the webpage illustrated in FIG. 28, which is one embodiment of a publicly available view of a mortgage professional's profile. Here, the basic contact, employment, and licensing data for the broker and his or her company is displayed in portion 4110, and the transactions handled by the broker are listed in portion 4120. The user viewing the broker's profile is also invited to verify the broker and his or her company in the NMLS database by following Verify Now link 4130. This profile view accessible through the search results screen illustrated in FIG. 27 is also available to the user by searching for this mortgage professional's name via the search box from FIG. 11.

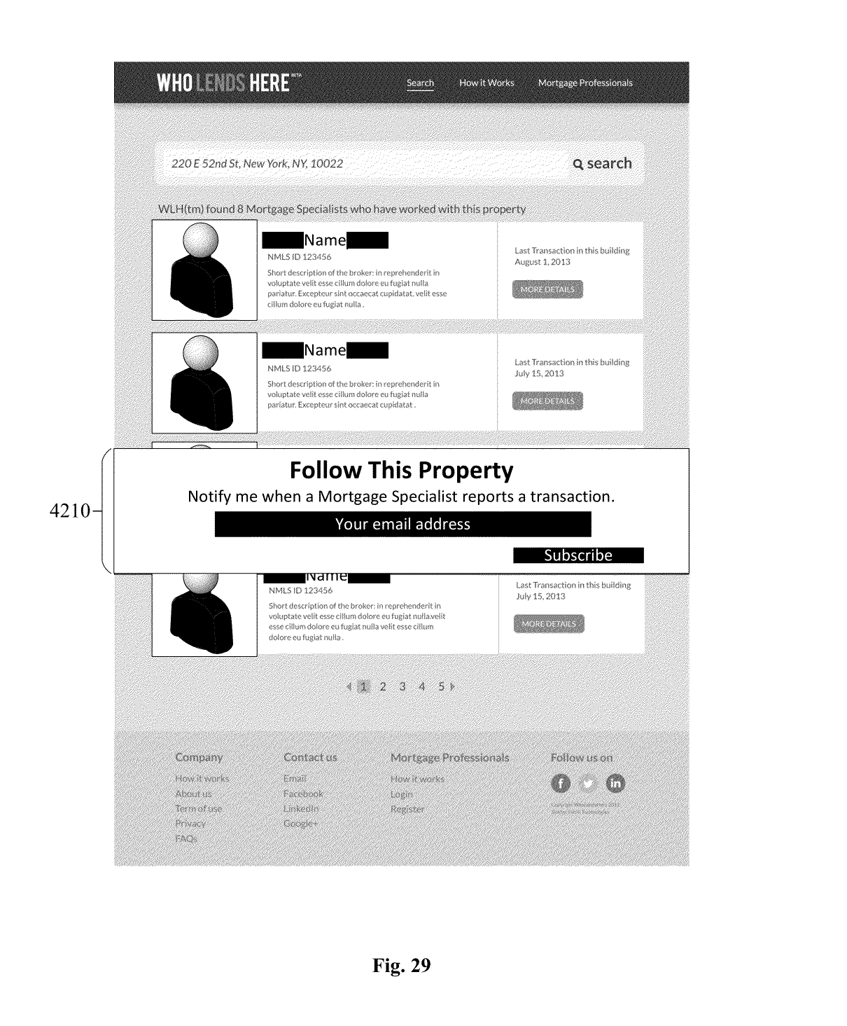

Turning back to the search results screen, FIG. 29 illustrates another embodiment of the results screen shown in FIG. 27. In FIG. 29, the WLH system invites the user to subscribe to email updates regarding the 999 E 52nd St. property searched for by the user. The user may subscribe to email updates by entering his or her email address and following the Subscribe link in pop-up box 4210. When the user subscribes to email updates, the WLH system automatically informs the user of new mortgage professionals that have handled transactions in this building, and other pertinent information.

The foregoing description of the various and preferred embodiments of the present invention has been presented for purposes of illustration and explanation. It is not intended to be exhaustive nor to limit the invention to the specifically disclosed embodiments. The embodiments herein were chosen and described in order to explain the principles of the invention and its practical applications, thereby enabling others skilled in the art to understand and practice the invention. However, many modifications and variations will be apparent to those skilled in the art, and are intended to fall within the scope of the invention, claimed as follows.

What is claimed is:

1. A method for identifying mortgage professionals, the method comprising:
receiving, over a computer network, a geographic identifier;
analyzing and processing the geographic identifier in accordance with a set of predetermined rules;
querying a database based on the processed geographic identifier, wherein the database comprises profiles of mortgage professionals, and wherein the profiles of mortgage professionals comprise records of properties for which the mortgage professionals have arranged a mortgage;
receiving information relating to mortgage professionals from the database based on the processed geographic identifier; and
providing information relating to mortgage professionals received from the database to a user.

2. The method of claim 1, wherein analyzing and processing the geographic identifier in accordance with a set of predetermined rules comprises determining whether the geographic identifier provides sufficient geographic parameters to perform a query in a database configured to accept queries based on geographic identifiers.

3. The method of claim 2, further comprising providing missing geographic parameters if the geographic identifier is determined to provide insufficient parameters.

4. The method of claim 1, wherein querying a database based on the processed geographic identifier comprises searching profiles of mortgage professionals for records of properties with geographic locations corresponding to the geographic identifier, for which the mortgage professionals have arranged a mortgage.

5. The method of claim 4, wherein the geographic identifier is a street address.

6. The method of claim 4, wherein the geographic identifier is a neighborhood name.

7. The method of claim 4, wherein providing information relating to mortgage professionals received from the database to a user comprises generating a webpage that lists mortgage professionals whose profiles comprise records that match the database query.

8. The method of claim 7, further comprising:
receiving a request from a user to view a profile of a mortgage professional from the displayed list; and
displaying a profile of a mortgage professional from the displayed list.

9. A method for identifying mortgage professionals, the method comprising:
registering a profile comprising information relating to a mortgage professional in a database available over a computer network, wherein the profile comprises a collection of records of mortgage transactions arranged by the mortgage professional, and wherein each mortgage transaction record is identifiable by a geographic identifier;
providing a visual interface to prospective borrower users;
receiving a request from a prospective borrower user in the form of a geographic identifier;
querying the database for mortgage transaction records based on the geographic identifier provided by the prospective borrower user;
identifying profiles of mortgage professionals that include mortgage transaction records corresponding to the geographic identifier provided by the prospective borrower user; and
providing the prospective borrower user, via the visual interface, with profiles of mortgage professionals, wherein the provided profiles of mortgage professionals comprise mortgage transactions corresponding to the geographic identifier provided by the prospective borrower user.

10. The method of claim 9, wherein the geographic identifier comprises one or more of a street address, a city, and/or a zip code.

11. The method of claim 10, wherein the visual interface provided to prospective borrower users is a web site accessible through a browser.

12. The method of claim 10, wherein the visual interface provided to prospective borrower users is a mobile app.

13. The method of claim 10, wherein the registering a profile comprising information relating to a mortgage professional comprises:
providing a visual interface to mortgage professional users;
receiving, from a mortgage professional user, a file comprising details relating to one or more mortgage transactions serviced by the mortgage professional;
processing the received file to check for errors;
providing the mortgage professional user with an opportunity to correct mortgage transaction details if an error is found in the received file; and
storing the mortgage transaction details in the database.

14. The method of claim 13, further comprising:
configuring the visual interface provided to prospective borrower users to accept requests in the form of geographic identifiers.

15. The method of claim 14, further comprising:
configuring the visual interface provided to prospective borrower users to accept requests in the form of text strings;
receiving a request in the form of a text string from a prospective borrower user;
querying the database for profiles of mortgage professionals based on the received text string; and
providing the prospective borrower user with a list of profiles of mortgage professionals that include the received text string.

16. A method for matching prospective borrowers with mortgage professionals, the method comprising:
providing a visual interface to users of a computer-based mortgage information platform, wherein the users comprise prospective borrowers and mortgage professionals;
registering a profile comprising information about a prospective borrower in a database available over a computer network;
registering a profile comprising information about a mortgage professional in a database available over a computer network;
signing-in a user with a registered profile;
receiving a request from a user with a registered profile to match the user with an appropriate prospective borrower or mortgage professional; and
automatically matching the signed-in user with a prospective borrower or mortgage professional based on parameters found in the signed-in user's registered profile, wherein signed-in prospective borrower users are matched with mortgage professionals, and signed-in mortgage professional users are matched with prospective borrowers.

17. The method of claim 16, wherein the profile comprising information about a prospective borrower comprises financial data relating to the prospective borrower.

18. The method of claim 17, wherein the financial data relating to the prospective borrower comprises the prospective borrower's annual income, savings amounts, and/or credit score.

19. The method of claim 16, further comprising providing the requesting user, via a visual interface, with a list of matching prospective borrowers or mortgage professionals.

20. The method of claim 19, further comprising providing the requesting user, via the visual interface, a listing of parameters based on which the listed prospective borrowers or mortgage professionals match the requesting user's profile.
